(19) United States
(12) Patent Application Publication
(10) Pub. No.: US 2005/0096044 A1
(43) Pub. Date: May 5, 2005

(54) Transmitter at specific address transmitting address-specific informational content

(76) Inventors: William E. Haberman, Celebration, FL (US); John V. Ivsan, Charlotte, NC (US); Chad D. Tillman, Charlotte, NC (US); Brian D. MacDonald, Charlotte, NC (US)

Correspondence Address: TILLMAN IVSAN, PLLC, PO BOX 471581, CHARLOTTE, NC, 28247, US

(21) Appl. No.: 10/980,136

(22) Filed: Nov. 1, 2004

Related U.S. Application Data
(60) Provisional application No. 60/516,351, filed on Oct. 31, 2003.

(51) Int. Cl. H04Q 7/20

(52) U.S. Cl. 455/422.1

(57) ABSTRACT

A method for presenting to a person using a mobile device informational content pertaining to a specific address when the mobile device is within proximity to the specific address includes the step of transmitting from the specific address a transmission containing a broadcast, wherein the broadcast includes informational content that pertains to the specific address for presenting to a person using the mobile device.

### CROSS-REFERENCE TO RELATED APPLICATIONS

The present application is a nonprovisional patent application of, and claims priority under 35 U.S.C. § 119(e) to, U.S. provisional patent application Ser. No. 60/516,351, filed Oct. 31, 2003, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The advent of a wireless age is here with eateries, libraries, and airports offering wireless Internet access “hot-spot” areas. Wireless Internet access ranges of these hot-spot areas extend beyond the seating areas of coffee shops and into the roadways and public spaces. Thus the user of a laptop computer with a wireless interface can find intermittent Internet access in moving about a typical urban area. It is expected that the lure of mobile computer usage away from the confines of an office for flexibility and freedom will motivate a closing of the gaps between current hot spots to effect seamless internet access areas encompassing many populated areas.

Navigating the internet is, however, generally an activity that requires considerable concentration. Thus, a driver attempting to gain information about nearby businesses by navigating the internet on a typical laptop computer is potentially at risk of becoming inadvertently involved in a vehicular accident. Even a pedestrian in motion on a sidewalk can be at risk of injury if not wary of the immediate environment.

Utilizing currently popular technology to wirelessly and safely receive information on a mobile device may be limited to receiving transmissions from commercial radio stations. In many urban environments, literally dozens of commercial radio stations provide music, news, commercial advertising, and other programming to listeners. It is infrequent, however, when a listener happens to receive current information useful in their immediate environment. For example, a motorist seeking a particular product, service, or business does not typically expect advertisements available through a typical radio to provide immediately pertinent information.

Signage advertising along roadways does offer information regarding products and services in the vicinity of a motorist or pedestrian, but the information is not content rich and is not easily recorded or searched. Often views of distant signs are occluded by nearby signs as businesses visually crowd public spaces with attention grabbing strategies that are not designed for enabling a consumer to meaningfully acquire, record, organize, and review useful information.

### SUMMARY OF THE INVENTION

The invention includes many aspects and features. Fourteen aspects and several features are summarized below, while additional aspects and features are disclosed in the following detailed description section.

### First Aspect of the Invention

A first aspect of the invention includes a system for presenting informational content to a person using a mobile device. The system includes a wireless transmitter that transmits a transmission containing a broadcast; and a mobile device configured to receive the transmission from the wireless transmitter when the mobile device is within a transmission range of the transmitter. The transmitter unilaterally transmits the transmission without regard to whether the mobile device actually is within the transmission range of the transmitter. Moreover, the broadcast contained within the transmission includes informational content for presentation to a person, and the mobile device is configured to store therein the informational content for presentation to a person using the mobile device.

The first aspect of the invention also includes a method for practice in a system for presenting informational content to a person using a mobile device. The method includes the steps of unilaterally transmitting, with a wireless transmitter, a transmission containing a broadcast for receipt by mobile devices that are within a transmission range of the transmitter, wherein the broadcast includes informational content for presentation to people using the mobile devices; receiving, with a mobile device, the transmission when the mobile device is within the transmission range; and storing, within the mobile device, the informational content for presentation to a person using the mobile device.

The first aspect of the invention further includes a method for practice in a system for presenting informational content to a person using a mobile device. The method includes the steps of: unilaterally transmitting, with a wireless transmitter, a transmission containing a broadcast for receipt by mobile devices that are within a transmission range of the transmitter, wherein the broadcast includes informational content for presentation to people using the mobile devices; receiving, with a mobile device, the transmission when the mobile device is within the transmission range; and storing, within the mobile device, the informational content for presentation to a person using the mobile device. Furthermore, the step of transmitting is performed without regard to whether any communication has been received from the mobile device, and the informational content of the broadcast does not pertain to communications between the transmitter and the mobile device.

### Second Aspect of the Invention

A second aspect of the invention includes a system for presenting informational content to a person using a mobile device. The system includes a wireless transmitter that transmits a transmission containing a broadcast without regard to whether the presence of a mobile device has been detected within the transmission range of the transmitter; and a mobile device configured to receive the transmission from the wireless transmitter when the mobile device is within a transmission range of the transmitter. The broadcast contained within the transmission includes informational content for presentation to a person, and the mobile device is configured to store therein the informational content for presentation to a person using the mobile device.

The second aspect of the invention also includes a method for practice in a system for presenting informational content to a person using a mobile device. The method includes the steps of transmitting, with a wireless transmitter, a transmission containing a broadcast without regard to whether a mobile device actually is within a transmission range, wherein the broadcast includes informational content for presentation to a person; receiving, with a mobile device, the transmission when the mobile device is within the transmission range; and storing, within the mobile device, the informational content for presentation to a person using the mobile device.

The second aspect of the invention further includes a method for practice in a system for presenting informational content to a person using a mobile device. The method includes the steps of: transmitting, with a wireless transmitter, a transmission containing a broadcast without regard to whether a mobile device actually is within a transmission range, wherein the broadcast includes informational content pertaining to a particular location for presentation to a person; receiving, with a mobile device, the transmission when the mobile device is within the transmission range; storing, within the mobile device, the informational content for presentation to a person using the mobile device; and continuing to store the informational content within the mobile device following presentation of the informational content for subsequent presentation to a person using the mobile device.

### Third Aspect of the Invention

An additional, third aspect of the invention includes a system for presenting informational content to a person using a mobile device. The system includes: a wireless transmitter that transmits a transmission containing a broadcast; and a mobile device configured to receive the transmission from the wireless transmitter when the mobile device is within a transmission range of the transmitter. In this respect, the transmitter unilaterally transmits the transmission without regard to whether the mobile device actually is within the transmission range of the transmitter. Additionally, the broadcast contained within the transmission includes both informational content for presentation to a person and broadcast-identifying information. Moreover, the mobile device is configured to store therein the informational content for presentation to a person using the mobile device, wherein the informational content is stored in association with the broadcast-identifying information.

The third aspect of the invention also includes a method for practice in a system for presenting informational content to a person using a mobile device. The method includes the steps of: unilaterally transmitting, with a wireless transmitter, a transmission containing a broadcast without regard to whether a mobile device actually is within a transmission range, wherein the broadcast includes both informational content for presentation to a person and broadcast-identifying information; moving a mobile device to within transmission range of the wireless transmitter; receiving with the mobile device the transmission; and storing within the mobile device the informational content in association with the broadcast-identifying information for presentation of the informational content to a person using the mobile device.

The third aspect of the invention further includes a method for practice in a system for presenting informational content to a person using a mobile device. The method includes the steps of: unilaterally transmitting, with a wireless transmitter, a transmission containing a broadcast without regard to whether a mobile device actually is within a transmission range, wherein the broadcast includes both informational content pertaining to a particular location for presentation to a person and broadcast-identifying information comprising a broadcast identification; moving a mobile device to within transmission range of the wireless transmitter; receiving with the mobile device the transmission; and storing within the mobile device the informational content in association with the broadcast-identifying information for presentation of the informational content to a person using the mobile device.

### Fourth Aspect of the Invention

A fourth aspect of the invention includes a method for identifying broadcasts for acquisition and storage within a mobile device. The method includes the steps of receiving a plurality of broadcasts, wherein each broadcast includes both informational content for presentation to a person and broadcast-identifying information; and, for each respective broadcast that is received, determining whether the respective broadcast has previously been received by comparing the broadcast-identifying information of the respective broadcast with broadcast-identifying information of previously received broadcasts. The method further may include the step of storing within the mobile device the informational content of a broadcast that has not previously been received, wherein the informational content of the broadcast is stored in association with the broadcast-identifying information thereof.

The fourth aspect of the invention also includes a method for acquiring and storing broadcasts within a mobile device. The plurality of broadcasts may be received in a plurality of transmissions. The method includes the steps of: receiving a plurality of broadcasts, wherein each broadcast includes both informational content pertaining to a particular location for presentation to a person and broadcast-identifying information; for each respective broadcast that is received, determining whether the respective broadcast has previously been received by comparing the broadcast-identifying information of the respective broadcast with broadcast-identifying information of previously received broadcasts; and storing within the mobile device the informational content of a broadcast that has not previously been received, wherein the informational content of the broadcast is stored in association with the broadcast-identifying information thereof.

The broadcast-identifying information may include a broadcast identification, and determining whether a respective broadcast has already been received may include comparing the broadcast identification thereof against a list of broadcast identifications for broadcasts that have already been received. In this regard, a broadcast identification may represent a unique identification of the informational content of the broadcast, and a match between broadcast identifications in the comparison may indicate that the identical informational content of the broadcast has already been received, in which case the method further includes not storing the informational content of the received broadcast.

Alternatively, the broadcast-identifying information may include an identification of a version of the broadcast, and a match between broadcast identifications in the comparison may indicate only that the identical informational content of the broadcast possibly has been received. In this regard, the broadcast-identifying information further may include an indication that the broadcast is an updated broadcast for a previously received broadcast, in which case the method may include the step of storing the informational content of the received broadcast in place of the informational content of the previously received broadcast having the matching broadcast identification.

In a feature, the broadcast identification of a received broadcast and the informational content stored in association therewith may be cleared from the mobile device after a predetermined period of time, or on demand at the discretion of a user. In another feature, a computer-readable medium having computer-executable instructions performs the method.

### Fifth Aspect of the Invention

A fifth aspect of the invention includes a method for presenting informational content stored in a mobile device. The method includes the steps of: receiving a plurality of broadcasts, wherein each broadcast includes both informational content for presentation to a person and broadcast-identifying information; for each respective broadcast of the plurality, storing the informational content of the respective broadcast within the mobile device for presentation to a person using the mobile device, wherein the informational content is stored in association with the broadcast-identifying information for the respective broadcast; receiving, through a user interface of the mobile device, input from a person using the mobile device; identifying informational content to present to the person using the mobile device as a function of the received input and the broadcast-identifying information associated with the stored informational content; and presenting the selected informational content to the person using the mobile device.

In a feature, the step of identifying informational content includes searching the stored informational content as a function of the received user input. Furthermore, the received input may comprise a preferences profile for screening of the received broadcasts, or may comprise a selection by a person using the mobile device of a received broadcast from a list of received broadcasts.

The fifth aspect of the invention further includes a method for presenting informational content of a governmental broadcast. The method includes the steps of: receiving a plurality of broadcasts, wherein each broadcast includes both informational content for presentation to a person and broadcast-identifying information; for a broadcast including broadcast-identifying information indicating that the received broadcast is a governmental broadcast, automatically presenting the informational content of the governmental broadcast to the person using the mobile device; and for each broadcast including broadcast-identifying information indicating that the received broadcast is other than a governmental broadcast, storing the informational content of the broadcast within the mobile device for presentation to a person using the mobile device, wherein the informational content is stored in association with the broadcast-identifying information for the broadcast.

### Sixth Aspect of the Invention

A sixth aspect of the invention includes a method of receiving and storing within a mobile device certain broadcasts to the exclusion of other broadcasts. The method includes the steps of: storing a preferences profile from a person using the mobile device, wherein the preferences profile represents the types of informational content with which the person using the mobile device desires to be presented; receiving a plurality of broadcasts, wherein each broadcast includes both informational content for presentation to a person and broadcast-identifying information; and for each respective broadcast that is received, screening the broadcast against the received preferences profile to determine whether the respective informational content of the respective broadcast is to be stored within the mobile device.

In a feature, the broadcasting-identifying information also may include a broadcaster identification, wherein the broadcaster identification represents the author of the informational content of a broadcast. The preferences profile may include a broadcaster identification by which broadcasts are screened or a transmitting party identification by which broadcasts are screened.

The sixth aspect of the invention further includes another method of receiving and storing within a mobile device certain broadcasts to the exclusion of other broadcasts. This method includes the steps of: storing a preferences profile from a person using the mobile device, wherein the preferences profile represents the types of informational content with which the person using the mobile device desires to be presented; and receiving a plurality of broadcasts in transmissions from a plurality of transmitters. Each transmission contains a transmitting party identification, wherein the transmitting party identification represents the party of the transmitter by which the broadcast is transmitted in the transmission. Furthermore, each broadcast includes both informational content for presentation to a person and broadcast-identifying information, wherein the broadcast-identifying information includes a broadcaster identification. Moreover, the broadcaster identification represents the author of the informational content of a broadcast. The method further includes, for each respective broadcast that is received, screening broadcaster identifications and broadcast identifications against the received preferences profile to determine whether informational content of a respective broadcast is to be stored within the mobile device.

The sixth aspect of the invention further includes yet another method of receiving and storing within a mobile device certain broadcasts to the exclusion of other broadcasts. The method includes the steps of: storing a preferences profile from a person using the mobile device, wherein the preferences profile represents the types of informational content with which the person using the mobile device desires to be presented; receiving a plurality of broadcasts, wherein each broadcast includes both informational content for presentation to a person and broadcast-identifying information, wherein the broadcast-identifying information includes a broadcaster identification representing the author of the informational content of a broadcast; for each respective broadcast that is received for which the broadcast-identifying information indicates that the received broadcast is a governmental broadcast, automatically presenting the informational content of the governmental broadcast to the person using the mobile device; and for each respective broadcast that is received that is not a governmental broadcast, screening the broadcast against the received preferences profile to determine whether the respective informational content of the respective broadcast is to be stored within the mobile device.

### Seventh Aspect of the Invention

A seventh aspect of the invention includes a method for practice in a system in which broadcasts are transmitted in transmissions from wireless transmitters. The method is for presenting informational content of selected broadcasts to a person using a mobile device that is within transmission range of the wireless transmitters, and the method includes the steps of: receiving with the mobile device a plurality of transmissions from the wireless transmitters, wherein each transmission including a broadcast including informational content for presentation to a person; determining proximity of the wireless transmitter of each transmission that is received; and, using the mobile device, presenting the informational content to the person for the respective broadcast that is transmitted from a transmitter determined to be within a predetermined proximity to the mobile device at the time of presentation.

The seventh aspect of the invention further includes a method for practice in a system in which broadcasts are transmitted in transmissions from wireless transmitters. The method is for presenting informational content of selected broadcasts to a person using a mobile device that is within transmission range of the wireless transmitters, and the method includes the steps of: receiving with the mobile device a plurality of transmissions from the wireless transmitters, wherein each transmission includes a broadcast including informational content for presentation to a person; determining proximity of the wireless transmitter of each transmission that is received; and, using the mobile device, presenting the informational content to the person for the respective broadcast that is transmitted from a transmitter determined to be nearest to the mobile device at the time of presentation.

When the mobile device is moved to within transmission range of a different plurality of wireless transmitters, the method further include the steps of: receiving with the mobile device a plurality of transmissions from the wireless transmitters, wherein each transmission includes a broadcast including informational content for presentation to a person; determining proximity of the wireless transmitter of each transmission that is received; and, using the mobile device, presenting the informational content to the person for the respective broadcast that is transmitted from a transmitter determined to be within a predetermined proximity to the mobile device at the time of presentation.

The informational content may be presented as the transmission containing the respective broadcast is received, in which case the informational content is not stored within the mobile device. Alternatively, the method includes the step of storing the informational content whereby the informational content may be presented on demand upon instruction of a person using the mobile device. The instruction of the person using the mobile device may be received by way of actuation of a user input of the mobile device.

A determination of “deemed” proximity of a wireless transmitter may be made based on signal strength of the transmission received from the wireless transmitter. Alternatively, a more accurate determination of proximity of a wireless transmitter may be made based on information identifying the location of the transmitter that is included in the transmission. The information identifying the location may comprise positional data. Moreover, the mobile device may include GPS capabilities, whereby the GPS data of the mobile device can be compared with the positional data contained in the transmission in determining proximity of the wireless transmitter. In this regard, the positional data received from the transmitter may include GPS data, including longitudinal, latitudinal and elevational coordinates.

In a feature of the invention, the method further includes the step of storing a preferences profile from a person using the mobile device, wherein the preferences profile indicates types of informational content with which the person using the mobile device desires to be presented. In this regard, the informational content of a respective broadcast may not be presented to a person using the mobile device if the type of informational content does not match a type of informational content indicated in the preferences profile.

Alternatively, the preferences profile indicates types of informational content with which the person using the mobile device does not desire to be presented. In this regard, the informational content of a respective broadcast may not be presented to a person using the mobile device if the type of informational content matches a type of informational content indicated in the preferences profile.

In another feature, transmissions received by the mobile device each includes therein a transmitting party identification, and the method further includes the step of storing a preferences profile for a person using the mobile device wherein the preferences profile indicates a transmitting party identification. In this regard, the informational content of a respective broadcast may not presented to a person using the mobile device if the transmitting party identification does not match a transmitting party identification indicated in the preferences profile. Alternatively, the informational content of a respective broadcast may not be presented to a person using the mobile device if the transmitting party identification matches a transmitting party identification indicated in the preferences profile.

### Eighth Aspect of the Invention

An eighth aspect of the invention includes a method for practice in a system in which broadcasts are transmitted from wireless transmitters. The method is for presenting informational content of one or more selected broadcasts to a person using a mobile device that is within transmission range of each wireless transmitter and that has stored therein a preferences profile indicating at least one type of informational content. The method includes the steps of: receiving with the mobile device broadcasts from the wireless transmitters, wherein each broadcast includes informational content for presentation to a person; selecting a particular broadcast, which includes the steps of determining a proximity indicator for a wireless transmitter from which a broadcast is received, and determining whether the type of the informational content of a received broadcast is presentable according to the preferences profile; and, using the mobile device, presenting to the person the informational content of the selected particular broadcast. Determining a proximity indicator may include: measuring a signal strength; or comparing GPS data related to the position of the mobile device to positional data from the wireless transmitter. In this regard, the positional data may include GPS data related to the position of the wireless transmitter.

The step of selecting a particular broadcast may include selecting, from among all of the received broadcasts having informational content that is presentable according to the preferences profile, a broadcast having the greatest signal strength. Alternatively, selecting a particular broadcast may include identifying a set of all of the received broadcasts that have informational content that is presentable according to the preferences profile, and selecting from the identified set a broadcast having the greatest signal strength.

### Ninth Aspect of the Invention

A ninth aspect of the invention includes a method for practice in a system in which broadcasts are transmitted in transmissions from wireless transmitters. The method is for storing informational content of selected broadcasts for later presentation to a person using a mobile device that is within transmission range of the wireless transmitters, and the method includes the steps of: receiving with the mobile device a plurality of transmissions from the wireless transmitters, wherein each transmission includes a broadcast including informational content for presentation to a person; determining proximity of the wireless transmitter of each transmission that is received; and storing within the mobile device, for later presentation to a person using the mobile device, the informational content of each respective broadcast that is transmitted from a transmitter determined to be within a predefined proximity to the mobile device at the time of reception.

### Tenth Aspect of the Invention

A tenth aspect of the invention includes a method for practice in a system in which broadcasts are transmitted in transmissions from wireless transmitters. The method is for presenting informational content to a person using a mobile device that is within transmission range of the wireless transmitters, and the method includes the steps of: receiving with the mobile device a plurality of transmissions from the wireless transmitters, wherein each transmission includes a broadcast including informational content for presentation to a person using the mobile device; determining proximity of the wireless transmitter of each transmission that is received; scanning, for preselected types of informational content, each respective broadcast of the received transmissions that are transmitted from a transmitter determined to be within a predefined proximity to the mobile device at the time of reception; and presenting to a person using the mobile device a list representative of the informational content of those broadcasts found in scanning to match the preselected types of informational content.

In a feature, the method further includes the step of receiving input from a person using the mobile device representative of a selection of an item on the presented list and, in response thereto, presenting the informational content of the broadcast represented by the selection to the person.

### Eleventh Aspect of the Invention

An eleventh aspect of the invention includes a method for practice in a system in which broadcasts are transmitted in transmissions from wireless transmitters. The method is for presenting audio content to a person using a mobile device that is within transmission range of the wireless transmitters, and the method includes the steps of: receiving with the mobile device a plurality of transmissions from the wireless transmitters, wherein each transmission includes a broadcast including audio content for presentation to a person using the mobile device; scanning each respective broadcast for preselected audio content; and presenting to a person using the mobile device a list representative of the audio content of those broadcasts found in scanning to match the preselected audio content.

In another feature, the method further includes the step of playing the audio content of a broadcast that is selected from the presented list. In still another feature, the method includes the step of storing the audio content of a broadcast within the mobile device. The broadcast for which audio content is stored within the mobile device may comprise a broadcast selected from the presented list. The audio content further may be encrypted, in which case the method further includes the step of decrypting the encrypted audio content prior to its presentation.

The eleventh aspect of the invention further includes another method for practice in a system in which broadcasts are transmitted in transmissions from wireless transmitters. The method is for presenting audio content to a person using a mobile device that is within transmission range of the wireless transmitters. The method includes the steps of: receiving with the mobile device a plurality of transmissions from the wireless transmitters, wherein each transmission includes a broadcast including audio content for presentation to a person using the mobile device; scanning each respective broadcast for preselected audio content; and automatically playing a broadcast determined in scanning to have a preselected audio content.

A preselected type of audio content may include, for example: an identification of an artist; an identification of a song; or an identification of an album. The wireless transmitter may include, for example, a satellite and the mobile device may include, for example, a satellite radio receiver.

In a feature, only those transmissions are scanned that determined to have been received from transmitters that are determined to be within a predetermined proximity to the mobile device.

In yet another feature, the method includes the step of determining, for each transmission that is received, those transmitters that are within a predefined proximity to the mobile device at the time of reception of the transmission, and wherein the scanning includes scanning only those transmissions that are received from transmitters that are determined to be within the predetermined proximity to the mobile device.

### Twelfth Aspect of the Invention

A twelfth aspect of the invention includes an apparatus for presenting to a person using a mobile device informational content pertaining to a specific address when the mobile device is within proximity to the specific address. The apparatus includes a wireless transmitter located at the specific address that transmits a transmission containing a broadcast. The broadcast includes informational content for presenting to a person using the mobile device. In particular, the informational content pertains to the specific address.

The twelfth aspect of the invention further includes a method for presenting to a person using a mobile device informational content pertaining to a specific address when the mobile device is within proximity to the specific address. The method includes the step of transmitting from the specific address a transmission containing a broadcast, wherein the broadcast includes informational content that pertains to the specific address for presenting to a person using the mobile device.

With regard to this aspect of the invention, the transmitter may transmit the transmission upon detection of the mobile device within the transmission range of the transmitter, and the apparatus may comprise a machine-readable medium containing machine-executable instructions for detecting when the mobile device comes within the transmission range of the transmitter, and transmitting the transmission containing the broadcast when the mobile device is within range and, thus, within proximity to the specific address.

In features, the apparatus further includes a computer connected to the wireless transmitter for controlling of the wireless transmitter, and the computer may be connected to a computer network for receiving the informational content to be included in the broadcast of the transmission.

In other features, the method includes transmitting informational content that includes: an identification of the property at the specific address; an identification of the number of occupants residing at the specific address; an identification of a legal name of an occupant of the specific address; contact information for an occupant of the specific address; an alarm condition for a building at the specific address; the location and activation of emergency exits, fire alarms, and fire suppression systems; a floor plan for a building at the specific address; sales information for real estate located at the specific address; rental information for real estate located at the specific address; mail and parcel receiving information; or delivery information.

### Thirteenth Aspect of the Invention

A thirteenth aspect of the invention includes a method for practice in a system in which wireless transmitters transmit transmissions containing broadcasts, wherein each respective broadcast includes informational content for presentation on a mobile device that wirelessly receives such transmission. The method is for determining the broadcasts to be included in a transmission, and the method includes the steps of: receiving by a first party from a second party informational content of the second party to be contained in a broadcast; receiving by the first party from the second party a selection of one or more wireless transmitters of the network for transmitting a transmission including the broadcast containing the received informational content; and assembling by the first party a plurality of broadcasts for inclusion in a transmission from a wireless transmitter selected by the second party, a broadcast of the transmission containing the informational content received by the first party from the second party.

In features, the method further includes the steps of receiving by the first party from the second party a selection of one or more predetermined times for transmitting a transmission including the broadcast containing the received informational content, and transmitting at a predetermined time a transmission including a broadcast containing the informational content received by the first party from the second party. The second party may be presented with a description of the locations of the wireless transmitters for selection. The description of the locations may include a description of the geographical locations of the wireless transmitters of the network. Moreover, the second party may be presented with an identification of respective predetermined times at which transmissions are made from each of the wireless transmitters of the network.

In another feature, the first party receives from the second party identifying-information and includes in the broadcast the informational content of the second party together with the identifying-information received from the second party. The identifying-information may include, for example: directions to a location to which the informational content pertains; an Internet address for acquisition of additional informational content; an identification of the second party; information describing the informational content; an identification of the type of the informational content; or information identifying a location to which informational content pertains, such as GPS data whereby a mobile device having GPS capabilities can determine a proximity of the location.

In additional features, the first party receives the informational content from the second party over the Internet, and the first party receives the selection of the wireless transmitters from the second party over the Internet.

### Fourteenth Aspect of the Invention

Yet a fourteenth aspect of the invention includes a method for distributing informational content pertaining to specific locations for presentation to a person using a mobile device. The method includes the steps of receiving by a first party from each of a plurality of second parties informational content pertaining to a specific location and location-identifying information for the specific location; maintaining by the first party in a database the received informational content pertaining to the specific locations in association with the received location-identifying information for the specific locations; and transmitting with a wireless transmitter a transmission, the transmission including a broadcast having the received informational content and the received location-identifying information as maintained in the database for a plurality of specific locations.

The fourteenth aspect of the invention further includes a method for presenting informational content pertaining to specific locations to a person using a mobile device. The includes the steps of: receiving, with a mobile device, a transmission including a broadcast, wherein the broadcast includes, for each of a plurality of specific locations, informational content pertaining to a specific location and location-identifying information for the specific location; storing, within the mobile device, for each of a plurality of specific locations, the received informational content in association with the received location-identifying information for the specific location; and identifying those specific locations that are within a predetermined proximity to the mobile device by searching the stored location-identifying information as a function of a current location of the mobile device.

In a feature, the method further includes presenting stored informational content for a specific location that is identified as being within a predetermined proximity to the current location of the mobile device.

In still another feature, the method further includes the steps of: receiving with the mobile device a transmission including a broadcast, wherein the broadcast includes, for each of a plurality of specific locations, informational content pertaining to the specific location and location-identifying information for the specific location; and updating the stored informational content and location-identifying information with the received informational content and location-identifying information, whereby the data stored in the mobile device may be augmented and updated.

In still yet a further feature, the first party receives over the Internet from one of the second parties informational content pertaining to a specific location and the location-identifying information for the specific location. In another feature, the first party provides a subscription service to each of the second parties under which the first party receives, from each of the second parties, the informational content pertaining to a specific location and the location-identifying information for the specific location. The subscription service may be provided to each of the second parties by the first party for a respective fee.

Transmitting may be performed repeatedly, whereby the informational content stored in association with the location-identifying information for the specific locations is kept current within the mobile devices. Alternatively, transmitting may be performed on a periodic basis, such as hourly or daily, whereby the informational content stored in association with the location-identifying information for the specific locations is kept current within the mobile devices.

### Additional Features of the Invention

Additional features of one or more aspects of the invention are further described below.

Accordingly, in another feature of the invention, the informational content broadly encompasses any information that is intended to be presented to a person using a mobile device. For example, and not by way of limitation, the informational content may include: audio; video; audiovisual; text; or an audiovisual presentation. Moreover, the informational content preferably is provided in a format that is compliant with predominant web browser software and, accordingly, the informational content readily may be presented through a web browser or similar software.

The informational content may pertain to: a good; a company; music; statistical information pertaining to a sports event; a specific traffic situation; road hazard information; a traffic accident; financial rates; current financial markets; an advertisement; or a news report.

The informational content also may pertain to a particular location. In this regard, the transmission range of the transmitter may cover the particular location to which the informational content pertains. The particular location to which the informational content pertains may include, for example: a store; a shopping center; a restaurant; a hotel; a public facility; a historical landmark; or a tomb, crypt, or grave.

The informational content pertaining to the particular location, in turn, may comprise: an address of the particular location; an identification of the owner of the particular location; a description of a product for sale at the particular location; pricing information for a product for sale at the particular location; a digital coupon for a product for sale at the particular location; a description of an available service offered at the particular location; pricing information for an available service offered at the particular location; a digital coupon for a service offered at the particular location; hours of operation for a business operating at the particular location; contact information for a business operating at the particular location; an estimated wait time for obtaining service from a service provider operating at the particular location; an indication of whether a business is currently open at the particular location; parking information for the particular location; employment information for a business operating at the particular location; information descriptive of or pertaining to a person located at the particular location; or information descriptive of a service sought by an entity at the particular location, such as a service provided by a taxi. The informational content pertaining to a particular location also could include statistical information pertaining to a sports event occurring at a particular location. In this regard, the sports event may be located within the transmission range of the wireless transmitter.

In yet another feature of the invention, the informational content of a broadcast is encrypted for security. In other features of the invention, the broadcast includes a digital signature whereby the author of the informational content of a broadcast can be verified; or the transmission from the transmitting party includes a digital signature whereby the transmitting party can be verified.

In still yet further features of the invention, informational content may be presented automatically without first receiving input from a person using the mobile device representing a request for the presentation; the transmitter transmits the transmission further without regard to whether any communication has been received from the mobile device; the informational content of the broadcast does not pertain to communications between the transmitter and the mobile device; or the mobile device receives the transmission and stores the informational content of the broadcast contained therein without having to obtain an IP address.

In yet another feature of the invention, the mobile device includes software for organizing and filtering informational content stored therein for selection and presentation thereof. The software may include a search engine such as that utilized by Google. The search engine may be used for searching the broadcast-identifying information or the stored informational content based on the received user input, and the results of the search may be presented to a person using the mobile device by order of relevancy, geographic location, or selected priority.

In a feature of the invention, a first transmission including a broadcast containing a first type of informational content may be transmitted on a first channel designated for carrying such informational content, and a second transmission including a broadcast containing a second type of informational content may be transmitted on a second channel designated for carrying such informational content. In this respect, the mobile device may be configured to receive transmissions on both channels.

The transmitting may be performed by a transmitting party, and the informational content of a broadcast of the transmission may be provided by another party different from the transmitting party. Furthermore, each transmission may contain a plurality of broadcasts, wherein each broadcast of the transmission contains informational content for presentation to a person, and the informational content of each respective broadcast of the transmission may be provided by a different party seeking to present its informational content to a person using the mobile device.

The transmission may be repeatedly transmitted, such as at predetermined intervals of time. The transmission also may include a cellular transmission; a WiMAX transmission; a WiFi transmission; a Bluetooth transmission; or a satellite transmission. The transmission may be transmitted using a wireless communication protocol in accordance with an IEEE 802 standard. Furthermore, the transmission may be made over one or more radio frequencies.

Depending on the intended implementation and desired range, the transmission range may be, for example: at least five miles or more; at least one mile or more; less than one mile; less than one kilometer; less than one hundred meters; less than one hundred feet; or less than ten feet.

The transmitter may include, for example, a WiFi transmitter, a WiMAX transmitter, a satellite, or a cell tower. The transmitter further may be may be stationary or mobile and, for example, may be mounted to a motor vehicle, such as a billboard vehicle. The transmitter also may be disposed in electrical communication with the Internet, or not. Similarly, the transmitter may be connected to a power grid; powered through solar energy; or battery powered.

The mobile device may comprise, for example: a computer; a mobile phone; a personal digital assistant (PDA); or a motor vehicle. The mobile device further may include an audiovisual system for presenting informational content, and further may include GPS capabilities for determining the current location of the mobile device. The mobile device also may include a satellite receiver disposed within a motor vehicle, in which case the satellite receiver may be removably mounted to the motor vehicle. Furthermore, in this regard, the mobile device may include a speaker system of the motor vehicle and computer-readable memory for storing of the informational content in association with the respective identifying information. The computer-readable memory may include a removable storage medium such as, for example, a memory card or optical disc, including a rewritable DVD disc. The computer-readable memory further may form part of a portable audio device, such as an MP3 player.

The informational content of a transmitted broadcast may continue to be stored within the mobile device following presentation of the informational content to a person using the mobile device. Alternatively, the informational content of a transmitted broadcast may not stored within the mobile device following presentation of the informational content to a person using the mobile device.

In yet additional features of the invention, the broadcast-identifying information: describes the informational content of the broadcast; includes a broadcast identification; or includes a version number of a broadcast having a broadcast identification (in this regard, the informational content of only the latest version of the broadcast may be stored within the mobile device).

If the informational content of the broadcast pertains to a particular location, then the broadcast-identifying information further may include: an identification of the particular location; include an address of the particular location; or include GPS data of the particular location.

The broadcast identification further may uniquely identify: a broadcast; the informational content of a broadcast; or, if the informational content pertains to a particular location, then the particular location.

In another feature, the transmission may contain a plurality of broadcasts. In this regard, each respective broadcast of the transmission contains both informational content for presentation to a person and broadcast-identifying information for the respective broadcast.

The step of storing may include storing within the mobile device the informational content in association with the broadcast identification if no informational content is previously stored within the mobile device in association with the broadcast identification.

In yet an additional feature, a broadcast is received including informational content for presentation to a person and broadcast-identifying information indicating that the received broadcast is a governmental broadcast. In accordance with this feature, the informational content of the governmental broadcast is automatically presented to the person using the mobile device. The informational content of the governmental broadcast may or may not be stored within the mobile device. Moreover, the informational content of the governmental broadcast may include, for example: information pertaining to a missing child; a picture of a missing child; information pertaining to an advisory from the national weather service; information pertaining to homeland security.

As will be appreciated, in a feature of the invention, receiving and storing or presenting of the informational content is automatically performed upon movement of a mobile device within a transmission range of a wireless transmitter transmitting a broadcast. In this regard, the mobile device monitors for transmissions wherein, upon moving into transmission range, the mobile device may receive the broadcast and store or present the informational content thereof in accordance with aforementioned aspects of the present invention. Accordingly, no user input is necessarily required at the time of the reception in order to store or present the informational content. Indeed, a preferences profile is utilized in certain aspects of the invention in order to conveniently obviate any requirement of user input prior to storing or presenting of the informational content following reception of a broadcast.

In addition to the aforementioned aspects and features of the invention, it should be noted that the invention further includes the various possible combinations of such aspects and features. For example, additional aspects of the invention include computer-readable medium containing computer-executable instructions (software) for performing the methods of the invention. Other examples of such combinations are illustrated in the detailed description set forth below.

### BRIEF DESCRIPTION OF THE DRAWINGS

One or more embodiments of the invention will now be described in detail with reference to the accompanying drawings, wherein,

FIG. 1 illustrates a system for presenting information content to a person using a mobile device in accordance with one or more aspects of the invention;

FIG. 2 shows a method for presenting informational content to a person using a mobile device in accordance with one or more aspects of the invention;

FIG. 3 illustrates an Internet-enabled mobile device downloading informational content in accordance with one or more aspects of the invention;

FIG. 4 shows a method for presenting by a mobile device informational content from a proximate transmitter in accordance with one or more aspects of the invention;

FIG. 5 illustrates a method for determining proximity and presenting information content in accordance with one or more aspects of the invention;

FIG. 6 illustrates another method for determining proximity and presenting information content in accordance with one or more aspects of the invention;

FIG. 7 illustrates a method that represents repetition of the method of FIG. 4 as a mobile device moves in accordance with one or more aspects of the invention;

FIG. 8 illustrates a system implementing a variation of the method of FIG. 7 in accordance with one or more aspects of the invention;

FIG. 9 illustrates a method whereby a configured mobile device presents preferred informational content in accordance with one or more aspects of the invention;

FIG. 10 illustrates a method utilized by the mobile device of FIG. 9 in accordance with one or more aspects of the invention;

FIG. 11 shows a variation of the method of FIG. 10 in accordance with one or more aspects of the invention;

FIG. 12 illustrates a method for determining proximity using GPS data and presenting preferred informational content by a mobile device in accordance with one or more aspects of the invention;

FIG. 13 illustrates a method for determining a proximity and presenting preferred informational content by a mobile device in accordance with one or more aspects of the invention;

FIG. 14 shows a mobile device that stores a preferences profile in accordance with one or more aspects of the invention;

FIG. 15 shows a method for identifying broadcasts for storage of informational content thereof to the exclusion of other broadcasts in accordance with one or more aspects of the invention;

FIG. 16 shows a method for storing content of updated broadcasts in place of previously stored content in accordance with one or more aspects of the invention;

FIG. 17 shows a method for determining broadcasts to be included in a transmission in accordance with one or more aspects of the invention;

FIG. 18 shows another method for determining broadcasts to be included in a transmission in accordance with one or more aspects of the invention;

FIG. 19 illustrates a network of wireless transmitters of a first party transmitting transmission including broadcasts of informational content of a second party method for determining broadcasts to be included in a transmission in accordance with one or more aspects of the invention;

FIG. 20 illustrates a system for presenting to a person using a mobile device information content pertaining to a specific address of a residential neighborhood;

FIG. 21 illustrates a broader view of the residential neighborhood of FIG. 20, thereby showing an evident benefit of the system of FIG. 20;

FIG. 22 illustrates another system for presenting to a person using a mobile device information content pertaining to a specific address of a residential neighborhood; and

FIG. 23 illustrates a preferred system in accordance with the fourteenth aspect of the present invention.

### DETAILED DESCRIPTION

As a preliminary matter, it will readily be understood by one having ordinary skill in the relevant art (“Ordinary Artisan”) that the invention is susceptible of broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Moreover, many embodiments, such as adaptations, variations, modifications, and equivalent arrangements, will be implicitly disclosed by the embodiments described herein and fall within the scope of the invention.

Accordingly, while the invention is described herein in detail in relation to one or more embodiments, it is to be understood that this disclosure is illustrative and exemplary of the invention, and is made merely for the purposes of providing a full and enabling disclosure of the invention. The detailed disclosure herein of one or more embodiments is not intended, nor is to be construed, to limit the scope of patent protection afforded the invention, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent a clear indication otherwise. Indeed, the steps in such processes or methods generally may be carried out in various different sequences and orders while still falling within the scope of the invention. Accordingly, it is intended that the scope of patent protection afforded the invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein-as understood by the Ordinary Artisan based on the contextual use of such term-differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at lease one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Turning now to the drawings,

### System and Methods of the Invention

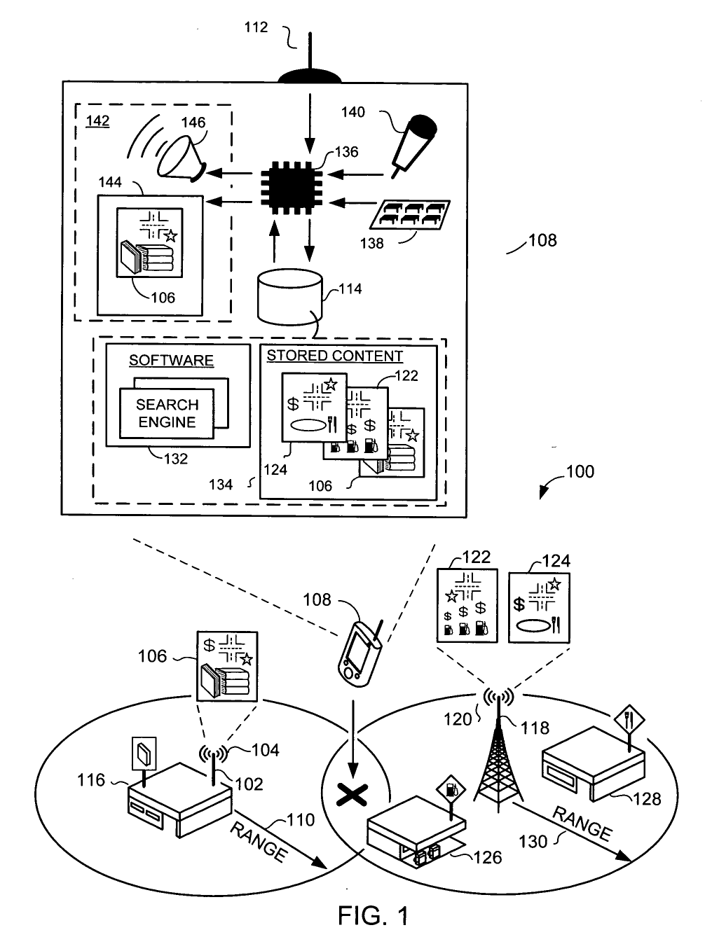

A system 100 in accordance with one or more aspects of the present invention is illustrated in FIG. 1. The system 100 is for presenting informational content to a person using a mobile device, and includes a wireless transmitter 102 and a mobile device 108.

The wireless transmitter transmits a transmission 104 having a broadcast containing informational content 106 for presentation to a person. Moreover, as will be discussed in detail below, the informational content 106 pertains to a particular location within the range of the transmitter 102.

The transmitter unilaterally transmits the transmission 104 without regard to whether mobile device 108 is located within a transmission range 110 of the transmitter. Furthermore, the transmitter 102 unilaterally transmits the transmission 104 without regard to whether the mobile device 108 has been detected within the transmission range of the transmitter, and, without regard to whether any communication has been received from the mobile device 108. Nor does the informational content 106 pertain to communications between the transmitter 102 and the mobile device 108, in that no handshaking or other two-way communication occurs between the transmitter 102 and the mobile device 108 in order for the transmitter 102 to transmit the transmission 104 of the broadcast containing the informational content 106. For example, no IP address is assigned to the mobile device 108 by the transmitter 102 as occurs when a wireless device registers with a WAN computer network.

The mobile device 108 includes a receiver 112 for receiving wireless transmissions such as transmission 104 and is configured to receive the transmission 104 from the wireless transmitter 102 when the mobile device 108 comes within transmission range 110 of the transmitter 102. The mobile device 108 further is configured to store the informational content 106 by way of, for example, a computer-readable storage medium 114 of the mobile device 108. The computer-readable medium 114 preferably comprises non-volatile memory, whereby the informational content may be stored for an extended period of time even if the mobile device is powered off.

In addition thereto, the mobile device 108 preferably includes a data processing unit 136 and a user interface for receiving input from a person using the mobile device 108 such as, for example, a keypad 138 or a microphone or sound sensitive element 140. The mobile device 108 further includes an audiovisual system 142 that includes a speaker component 146 and a display screen 144 for presenting informational content to the person such as, for example, the informational content 106 received by the mobile device 108 from the wireless transmitter 102. The display screen 144 and keypad 138 of the present invention preferably comprise a visual output device providing graphical visual presentation and an input-output device, such as a graphical user interface (GUI) providing a touch-actuated area as a virtual keypad.

As shown in FIG. 1, the mobile device 108 is located within transmission range 110 of transmitter 102 (“X” marks the spot) and, consequently, mobile device 108 has received and stored therein informational content 106 received from transmitter 102. The location to which the informational content 106 pertains is the location of a business 116 comprising a bookstore, but other locations certainly are within the scope of the invention.

The informational content 106 includes the address of the business complete with parking information, an identification of the entity that owns the business and contact information thereof, and a listing of the hours of operation. Furthermore, the informational content 106 includes information regarding products for sale and services available at the location of the business 116, as well as pricing information therefor. The informational content 106 also includes a digital coupon for a particular product, such as, in this bookstore example, a particular paperback book.

System 100 of FIG. 1 also includes another a wireless transmitter 118 that transmits transmission 120, which contains a plurality of broadcasts each containing respective informational content 122, 124 from two different businesses 126, 128 for presentation to a person using a mobile device within transmission range 130. Transmitting of transmission 120 is performed by a transmitting party which receives respective informational content from other parties (businesses 126, 128) seeking to present informational content 122, 124 to persons using mobile devices within a transmission range 130 of the transmitter 118.

Business 126 comprises a service station, and the informational content 122 includes, as illustrated in informational content 122, respective prices for the various grades of gasoline that are sold at the service station. The informational content is also shown as including an address and driving directions to the business 126 to assist a motorist in navigating to the service station in order to purchase fuel. Similarly, business 128 comprises a restaurant, and the informational content 124 includes, as illustrated in informational content 122, the menu offerings of the restaurant, respective prices, and an address and driving directions to the business 128 to assist a motorist in navigating to the restaurant. Preferably the transmitting party provides this service for a fee under a subscription agreement with each of the businesses 126, 128.

As further shown in FIG. 1, mobile device 108 also has come within transmission range 130 of transmitter 118 (note that the transmission ranges 110, 130 of the two transmitters 102, 118 overlap) and, consequently, mobile device 108 further has received and stored therein the informational content 122, 124 received from transmitter 118.

As will be appreciated, a lot of informational content may be acquired and stored by the mobile device 108 as it moves into transmission range of wireless transmitters. Accordingly, the mobile device 108 preferably includes software 132 for organizing and filtering the informational content 134 that is stored therein. The software preferably facilitates selection and presentation of informational content deemed relevant to a person using the mobile device 108. In this regard, the software preferably includes a search engine for execution by the data processing unit 136 of the mobile device 108, whereby stored informational content may be searched using input from the person and the results presented to the person in an orderly manner.

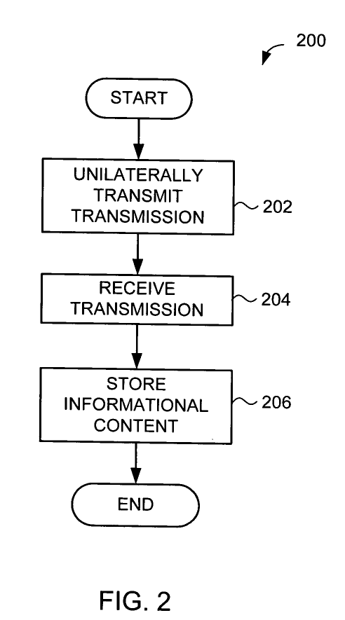

An exemplary, broad method 200 for presenting informational content to a person using a mobile device is explicitly shown in FIG. 2. In method 200, a transmission is unilaterally transmitted using a wireless transmitter in step 202. The transmission contains at least one broadcast for receipt by mobile devices that are within a transmission range of the transmitter, and the broadcast includes informational content for presentation to people using the mobile devices. Indeed, the transmission is received in step 204 by such a mobile device that has come within transmission range of the wireless transmitter. In step 206, the informational content of the broadcast is stored within the mobile device for presentation to a person using the mobile device.

### Broadcast-Identifying Information

In accordance with aspects of the present invention, a broadcast includes not only informational content for presentation to a person using a mobile device, but further includes broadcast-identifying information that identifies or describes the broadcast. In this regard, the mobile device preferably stores in non-volatile memory of the mobile device the informational content of a broadcast in association with the broadcast-identifying information. By storing the informational content of a broadcast in association with broadcast-identifying information for the broadcast, the broadcast-identifying information may be utilized in searching for and retrieving the informational content stored in the mobile device. The broadcast-identifying information may include, for example: an identification of the broadcast; a version number of a broadcast; an identification of a “broadcaster” (i.e., identification of the party responsible for the informational content); or an identification of the party transmitting the transmission. The broadcast-identifying information further may include a description of the informational content of the broadcast, and the broadcast identification may uniquely identify: a broadcast; the informational content of a broadcast; or, if the informational content pertains to a particular location, then the particular location. Moreover, if the informational content of the broadcast pertains to a particular location, then the broadcast-identifying information further may include: an identification of the particular location; an address of the particular location; or GPS data of the particular location.

For example, if the broadcast-identifying information includes a broadcaster identification, then the informational content stored in the mobile device may be searched based on the identification of the broadcaster. In other words, if a person using the mobile device desires to see informational content for a particular business, such as Barnes & Noble, then the person only need search stored informational content for a broadcaster identification for Barnes & Noble. This functionality of the invention is extremely helpful when a person is in an unfamiliar location and is unaware of business that are within proximity of the person but may be hidden from a direct line of sight. Simply searching the mobile device can, for example, reveal whether a desired business is within the area and even provide directions to the business. Moreover, it should further be noted that, even if a particular business is not sought by a person, a list of stores within proximity to the person nevertheless can be displayed using the mobile device. The person then may select any store of interest, whereupon stored informational content for the selected store is presented for further consideration by the person.

In an aspect of the present invention, a preferences profile (discussed in greater detail below) for a person is stored within the mobile device that specifies certain businesses or locations of interest that are preferred by the person. In this aspect, the mobile device preferably includes a button or icon which, upon actuation by the user, results in the presentation of a list of all preferred businesses or locations of interest within a certain proximity of the person. An example of such businesses or locations of interest that could be specified include, for example, certain coffee shops such as Starbucks, certain fueling stations such as Citgo, certain restaurants such as McDonalds, and certain locations of interest such as hospitals and urgent care centers. A person with such a mobile device is able then to quickly find a Starbucks, Citgo, McDonalds, hospital or urgent care center, if within proximity, regardless of the person's actual knowledge of the surroundings. It is believed that this would be extremely useful for business travelers and tourists.

### Internet-Enabled Mobile Device

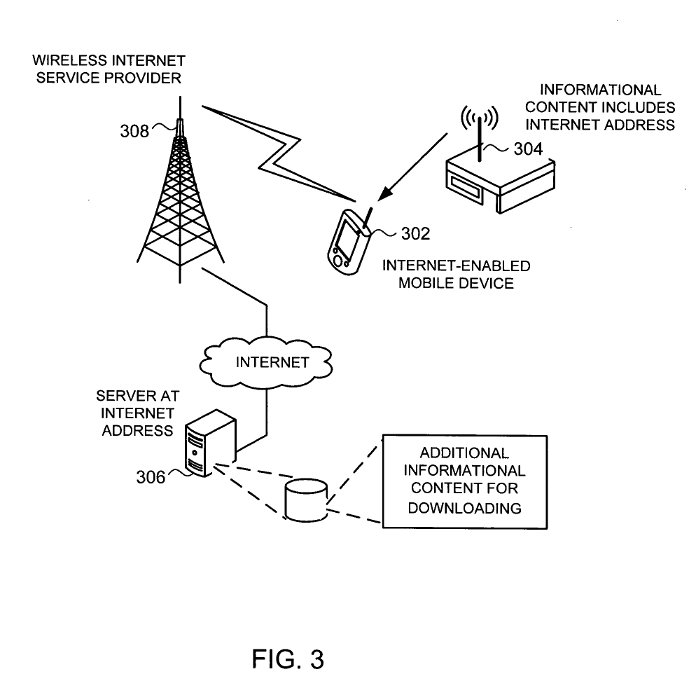

In a feature of the invention, the informational content may include, inter alia, an Internet address. In this regard, the mobile device preferably is Internet-enabled, whereby additional informational content may be downloaded from the Internet address using the mobile device. This is illustrated in FIG. 3, wherein an Internet-enabled mobile device 302 receives informational content—including an Internet address—from a wireless transmitter 304. In accordance with this feature, the mobile device contacts, by way of a transmitter 308 of a wireless Internet Service Provider, the Internet address and downloads from a server 306 additional informational content for presentation using the mobile device. The additional informational content may or may not be stored in the mobile device, as desired.

### Mobile Devices and Methods of the Invention

While the foregoing description was set forth generally with respect to a system and methods of the invention including wireless transmitters and mobile devices, the following descriptions generally focus upon the mobile devices and methods utilized by these mobile devices in accordance with aspects of the invention.

Furthermore, it will be appreciated that many of the following aspects pertain generally to various methods for presenting informational content without specific regard to whether the informational content is stored within the mobile device, whether prior to or following presentation. The scope of the invention includes both storing and not storing of the informational content in the mobile device and, therefore, the informational content may or may not be stored in non-volatile memory of the mobile device as desired in any particular implementation of the invention. Moreover, if the informational content is only presented and is not stored, then the informational content preferably is stored in volatile memory or otherwise cached, as necessary, in order for effecting presentation of the informational content.

### Presenting Proximate Informational Content

In an aspect of the invention, the mobile device is configured to present the informational content of a broadcast that is received from a transmitter determined to be within a predetermined proximity of the mobile device at the time of presentation.

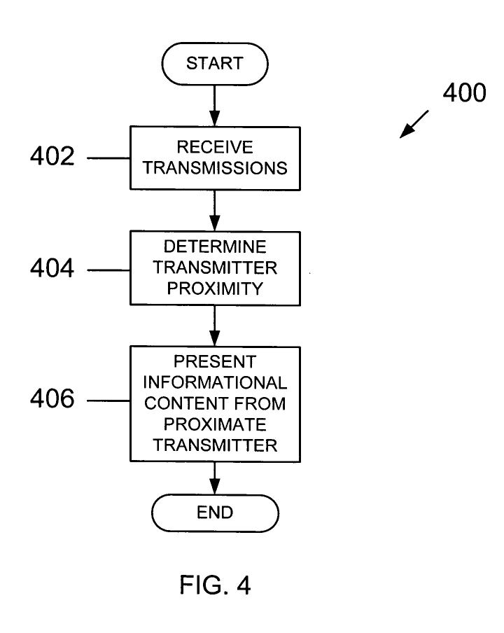

With regard to this aspect, FIG. 4 illustrates a general method 400 utilized by such a mobile device. In step 402, a plurality of transmissions from wireless transmitters is received by the mobile device, wherein each such transmission includes at least one broadcast. In step 404, a proximity of the transmitter for each received transmission is determined. In step 406, the informational content of a broadcast is presented if the broadcast is received in a transmission from a transmitter determined in step 404 to be within a predetermined proximity to the mobile device. The predetermined proximity may be specified by a person using the mobile device or programmed into the mobile device. Preferably, the proximity of a transmitter to the mobile device in method 400 is determined at the time of the presentation.

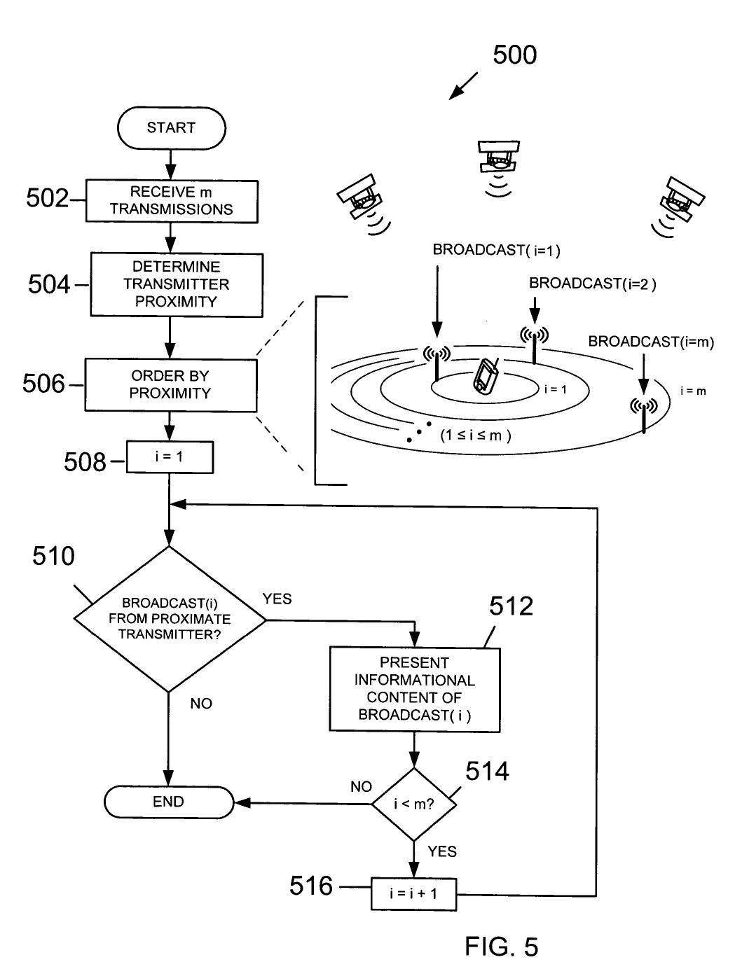

A method 500 for determining proximity using GPS data and presenting informational content from proximity transmitters based thereon is illustrated in FIG. 5. The method 500 may be used in conjunction with the system 100 of FIG. 1. In particular, in step 502 a plurality of transmissions is received from wireless transmitters by the mobile device, wherein each transmission includes a single broadcast conveying informational content for presentation. In FIG. 5, the integer “m” represents the number of received transmissions and, thus, broadcasts.

In step 504, a proximity of the transmitter for each received transmission is determined. In this regard, the mobile device preferably includes GPS capabilities, and transmitter proximity is determined utilizing positional data from each transmitter in conjunction with the GPS data of the mobile device.

In step 506, the m received broadcasts are ordered according to increasing transmitter proximities such that a transmission having the greatest proximity to the mobile device is first in order. In FIG. 5, the integer “i” denotes an index by which the ordering is to be understood such that “i=1” denotes a transmission having the greatest proximity and “i=m” denotes a transmission having the least proximity.

In step 508, the integer “i” is set at a value of “1” for initiation of a process for determining whether to present informational content from a broadcast of a transmission. The process begins with the transmission having the greatest determined proximity and proceeds in order of decreasing proximity.

Thus, in a first cycle of the process, in step 510 it is determined whether the transmission denoted by “i=1” is within a predetermined proximity of the mobile device. If it is determined in step 510 that the subject transmission is not from a “proximate transmitter,” i.e., a transmitter having a proximity within the predetermined proximity of the mobile device, then the method 500 ends. On the other hand, if it is determined that the subject transmission is from a proximate transmitter, then the broadcast of the transmission denoted by “i=1” is presented in step 512. Furthermore, it is also then determined in step 514 whether the current value of the integer “i” is less than the integer “m” wherein a negative determination denotes that all broadcasts currently received have been considered, and wherein a positive determination results in an increase by “1” in the integer “i” in step 516 such that the transmission denoted by “i=2” is next considered in step 510.

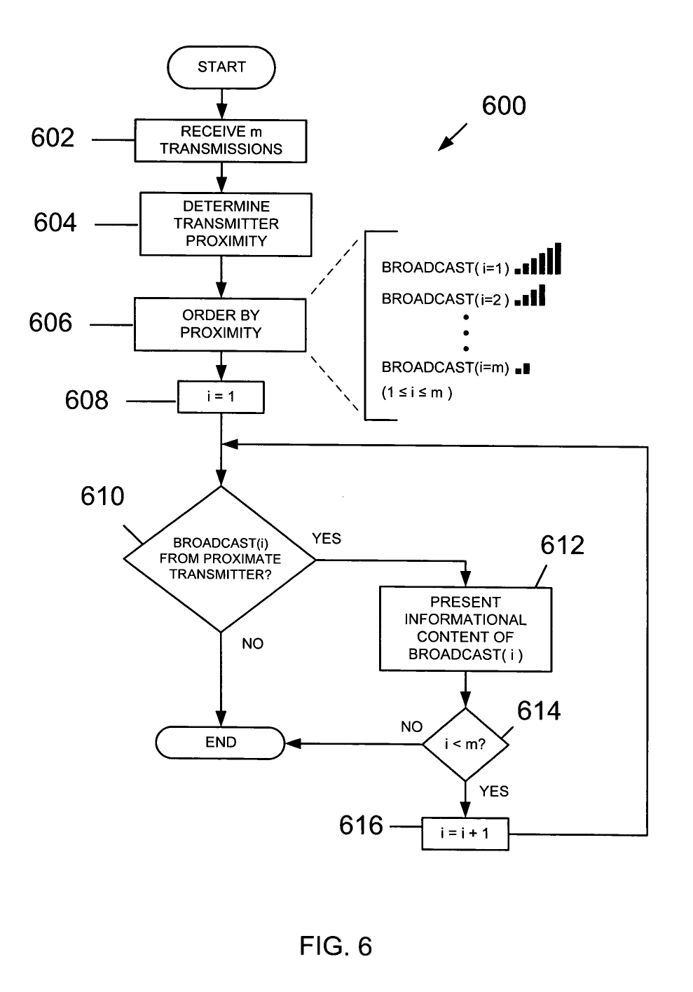

Yet another method 600 for determining proximity and presenting informational content from proximity transmitters based thereon is illustrated in FIG. 6. The method 600 may be used in conjunction with the system 100 of FIG. 1. In particular, in step 602 a plurality of transmissions are received from wireless transmitters by the mobile device, wherein each transmission includes a single broadcast conveying informational content for presentation. In FIG. 6, the integer “m” represents the number of received transmissions and, thus, broadcasts.

In step 604, a proximity of the transmitter for each received transmission is determined. In this regard, the mobile device does not include GPS capabilities, and transmitter proximity is determined by measuring signal strength of received transmissions and deeming the transmitters to be at certain proximities as a function of the measured signal strength.

Furthermore, it should be noted that determining proximities as a function of measured signal strength is not as accurate as using GPS data and, consequently, this method generally is preferred in cases where GPS data is unavailable. Indeed, reflections from objects, shielding by intervening structures, attenuation by varying air and weather conditions, and spatial field patterns of transmissions from an antenna may each affect a correspondence between the strength of a signal at a receiver and the distance over which the signal is transmitted. Nonetheless, an approximation of true proximity can be made in many transmitter-receiver arrangements based on the signal strength of the transmission at reception since signal strength generally reduces with increasing distance from its transmitter.

In step 606, the m received broadcasts are ordered according to increasing transmitter proximities such that a transmission having the greatest proximity to the mobile device (i.e., the transmission with the greatest signal strength) is first in order. In FIG. 6, the integer “i” denotes an index by which the ordering is to be understood such that “i=1” denotes a transmission having the greatest proximity and “i=m” denotes a transmission having the least proximity.

In step 608, the integer “i” is set at a value of “1” for initiation of a process for determining whether to present informational content from a broadcast of a transmission. The process begins with the transmission having the greatest determined proximity and proceeds in order of decreasing proximity.

Thus, in a first cycle of the process, in step 610 it is determined whether the transmission denoted by “i=1” is within a predetermined proximity of the mobile device. If it is determined in step 610 that the subject transmission is not from a “proximate transmitter,” i.e., a transmitter having a proximity within the predetermined proximity of the mobile device, then the method 600 ends. On the other hand, if it is determined that the subject transmission is from a proximate transmitter, then the broadcast of the transmission denoted by “i=1” is presented in step 612. Furthermore, it is also then determined in step 614 whether the current value of the integer “i” is less than the integer “m” wherein a negative determination denotes that all broadcasts currently received have been considered, and wherein a positive determination results in an increase by “1” in the integer “i” in step 616 such that the transmission denoted by “i=2” is next considered in step 610.

In a variation of method 400, the informational content of a broadcast is presented if the broadcast is received in a transmission from a transmitter that is determined to be nearest to the mobile device, rather than within a predetermined proximity to the mobile device. The nearest transmitter to the mobile device is identified by, again, determining the proximities of the transmitters from which transmissions are received by the mobile device. Moreover, for transmitters determined to be equal in proximity to the mobile device, the informational content of the broadcasts received from this plurality of transmitters may be presented.

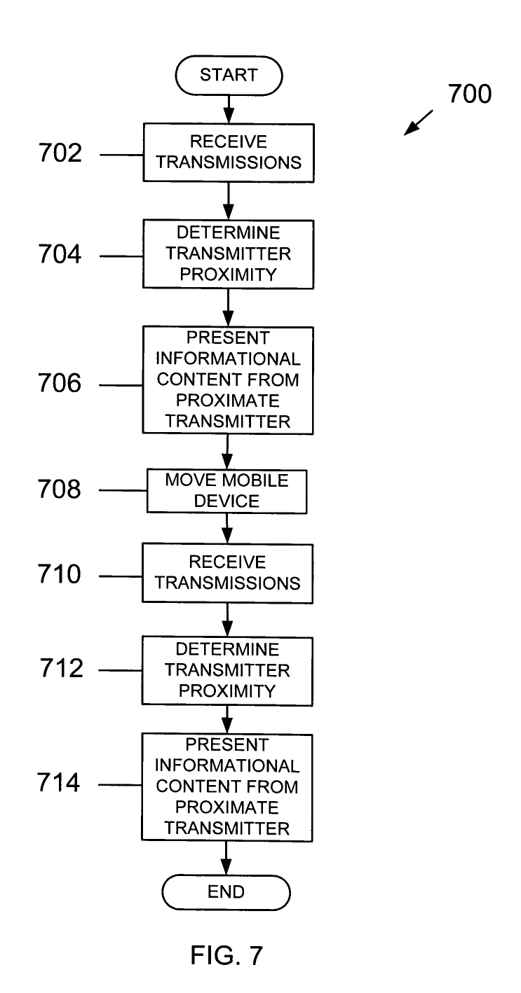

It is contemplated that during travel of the mobile device, the mobile device will come into range of a different plurality of transmitters. FIG. 7 illustrates a general method 700 that basically represents repetition of method 400 as the mobile device moves.

In particular, in step 702 transmissions from a first plurality of wireless transmitters are received by the mobile device. In step 704, a proximity of the transmitter for each received transmission is determined. In step 706, the informational content of a broadcast is presented if the broadcast is received in a transmission from a transmitter determined in step 704 to be within a predetermined proximity to the mobile device.

In step 708 the mobile device is moved or otherwise repositioned. Such repositioning may be accomplished through intermittent movement of the mobile device between successive steps of the illustrated method or the repositioning may be the result of continual movement of the mobile device at constant or varying speed during which other steps of the method proceed.

In step 710, transmissions from a second plurality of wireless transmitters are received by the mobile device. The second plurality of transmitters differs from the first plurality of transmitters by at least a change in one member of the plurality.

In step 712, for each received transmission of the second plurality, respective proximity of the transmitter to the mobile device is determined. In step 714, the informational content of a broadcast is presented if the broadcast is received in a transmission from a transmitter determined in step 712 to be within the predetermined proximity to the mobile device.

A particular benefit of an embodiment of the invention, an embodiment wherein the informational content of a broadcast is furthermore stored in a database if the broadcast is received in a transmission from a transmitter determined in step 712 to be within the predetermined proximity to the mobile device, is that a database of informational content available in the travels of the mobile device is collected over time. In this embodiment, the user of a mobile device, in route traveling about a community, is provided a database of goods and services conveniently available in the route. The database can be graphically represented on a display of the mobile device and can be searched and organized using software such as a search engine at any time.

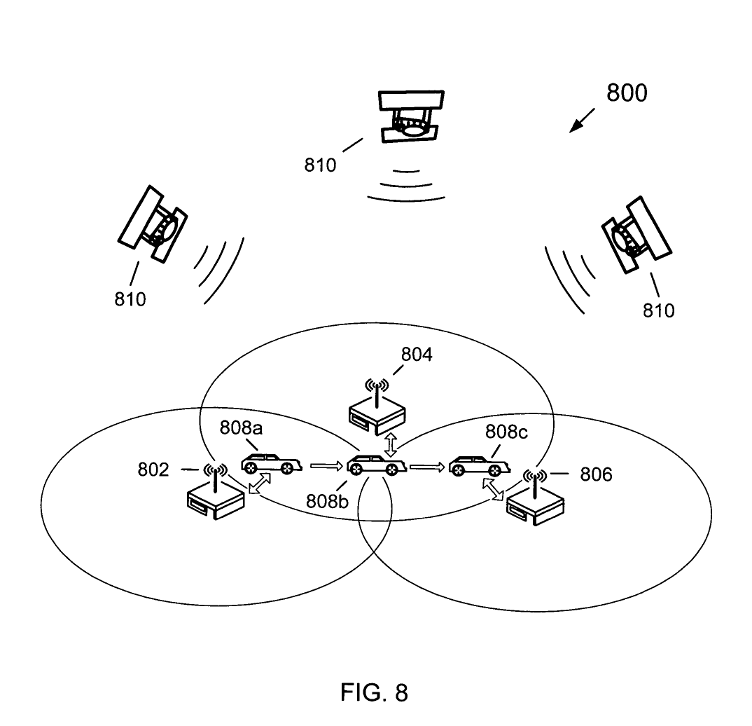

In a variation of method 700, the informational content of a broadcast is presented if the broadcast is received in a transmission from a transmitter that is determined to be nearest to the mobile device, rather than within a predetermined proximity to the mobile device. An illustration of this variation of method 700 is found in exemplary system 800 of FIG. 8, wherein wireless transmitters 802, 804, 806 each transmits a transmission containing a broadcast conveying informational content for presentation to a person. In this example, transmitters 802, 804, 806 are respectively co-located with particular locations comprising commercial business. The informational content provided in the broadcast of each of the respective transmitters conveys information about the goods or services provided at the respective location. Though three transmitters are shown in FIG. 8, this description is intended to relate to any number of transmitters.

System 800 includes an automobile 808 as an exemplary mobile device, in that the automobile is equipped with a mobile device as it moves about in the vicinity of the three transmitters. In this regard, the mobile device may comprise, in particular, electronic systems of the automobile. Alternatively, the automobile generally may constitute a mobile device by reason of a mobile device that is carried within the automobile, such as a handheld or console-mounted device. Indeed, such a device may be a handheld or console-mounted device that communicates directly with electronic systems of the automobile when carried therein and is portable with respect to the automobile so that the mobile device may be utilized in conjunction with and as part of the automobile as well as separately from the automobile. A simple example of a handheld device that may be used in conjunction with an automobile as well as separate from the automobile (but which does not practice the present invention) is the iPod manufactured by Apple Computer. The iPod may be utilized alone or in conjunction with an automobile manufactured by BMW, in that MP3 songs stored within the iPod may be played via the audio system of the BMW when the iPod is located within the BMW.

Referring again to FIG. 8, as the automobile 808 travels among the transmitters 802, 804, 806, a person within the automobile 808 is presented with informational content from the transmitter that happens to be nearest to the automobile 808 at the time of the presentation. Thus, when in a first position, the automobile 808a receives respective transmissions from wireless transmitters 802, 804. As the respective proximity of each transmitter 802, 804 is determined, the transmitter 802 is deemed to be the nearest to the automobile 808a and, accordingly, informational content received from transmitter 802 is presented to a person in automobile 808a.

Similarly, when in a second position along its travels, the automobile 808b receives respective transmissions from wireless transmitters 802, 804, 806. Determination of respective proximities of the transmitters reveals that transmitter 804 is deemed to be the nearest to the automobile 808b and, accordingly, the informational content received from transmitter 804 presented to a person in automobile 808b.

Finally, when in a third position along its travels, the automobile 808c receives respective transmissions from wireless transmitters 804, 806. Determination of respective proximities of the transmitters reveals that transmitter 806 is deemed to be the nearest to the automobile 808c and, accordingly, the informational content received from transmitter 806 presented to a person in automobile 808c.

A preferred method of determining transmitter proximities to a mobile device is based on calculations that utilize Global Positioning System (GPS) data. Referring again to FIG. 8, the automobile 808 preferably includes GPS capabilities whereby the position of the automobile 808 may be accurately determined at any given time by receiving signals from conventional GPS satellites 810. Furthermore, in the exemplary system 800 of FIG. 8, the transmissions from the transmitters 802, 804, 806 preferably contain positional data for the respective locations of the transmitters. Transmitter proximity thus is determined by comparing the GPS data of the automobile 808 with the GPS data of the transmitters.

It should be noted that the transmitters 802, 804, 806 are stationary and, thus, may not have GPS capabilities. Insofar as a transmitter possesses GPS capabilities, the positional data transmitted by the transmitter may be calculated utilizing the GPS satellite signals just as the automobile 808 calculates its positional data in FIG. 8. Insofar as a transmitter does not possess GPS capabilities, the positional data transmitted by the transmitter may be previously calculated by another device and stored in a non-volatile computer-readable storage medium available to the transmitter for inclusion in its transmissions.

Rather than using GPS data, transmitter proximity can be determined by measuring signal strengths of transmissions. In this regard, the transmission having the greatest signal strength when received at a mobile device may be deemed to be the nearest transmitter. Alternatively, each transmission may include data regarding the strength of the signal at the transmitter, and the transmission having the least relative reduction in signal strength when received at a mobile device may be deemed to be the nearest transmitter. The relative reduction in signal strength may be determined, for example, by comparing the signal strength at the mobile device to the signal strength at the source transmitter and calculating the percentage decrease in signal strength of the transmission.

### Presenting Preferred Informational Content

With further regard to a related aspect of the invention, a mobile device is configured to present informational content that is preferred by a person using the mobile device. Informational content which the person does not prefer is not presented using the mobile device.

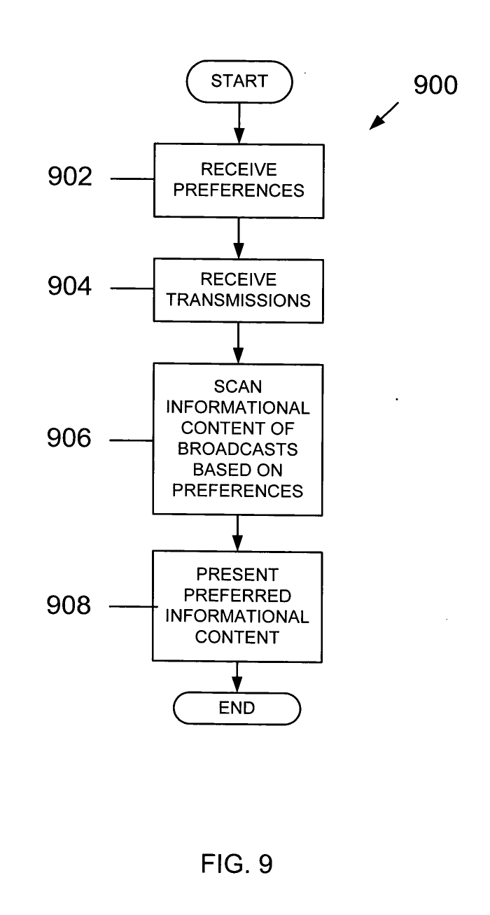

In this regard, FIG. 9 illustrates a general method 900 utilized by such a mobile device. In step 902, a person using the mobile device selects the types of informational content that are preferred.

The preferences received by the mobile device in step 902 preferably are recorded in a preferences profile for the person that is maintained within the mobile device.

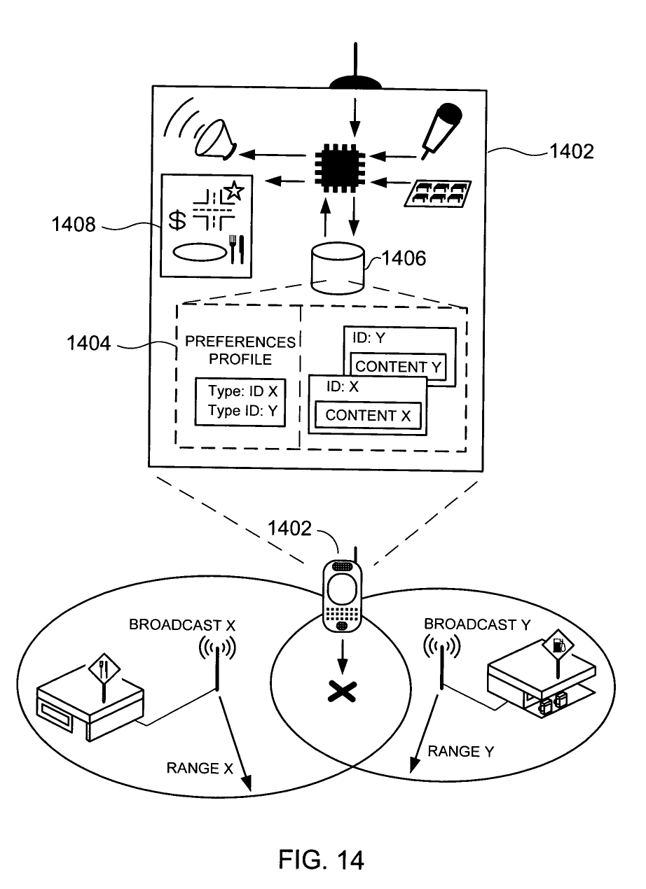

An exemplary mobile device comprising a “smart phone” 1402 and illustrating the storing therein of a preferences profile 1404 is shown in FIG. 14, wherein a user has selected informational content types “X” and “Y” for storing in the mobile device, and wherein broadcast “X” and broadcast “Y” has, in fact, been received and stored in a database 1406 maintained in non-volatile memory of the mobile device. FIG. 14 further shows the audiovisual presentation of the informational content 1408 for broadcast “X” pertaining to a restaurant and including a menu offering, driving directions, and prices. Preferably the user of the mobile device has selected, from a list of stored broadcasts, broadcast “X” for presentation of the informational content for the restaurant that is of current interest.

In one example, stored informational content is graphically represented to the user by the mobile device in an image on a display screen. In this example, the image graphically represents the physical location of the mobile device and surrounding area thereof as a map, depicting roadways, geographical features, or landmarks (for orientation and navigation purposes). The image further represents selections of stored informational content in accurate relative positions of the image. Preferably, the image is displayed on a graphical user interface (GUI) wherein the representations of selections of stored informational content mark touch sensitive areas of the GUI wherein actuation of a particular such area with the touch of a finger or stylus prompts particular stored informational content to be presented.

Returning to FIG. 9, a plurality of transmissions from wireless transmitters is received in step 904 by the mobile device, wherein each such transmission includes at least one broadcast. In step 906, each respective broadcast is scanned to determine if the informational content thereof matches informational content identified as being preferred in step 902. Subsequently, in step 908 the informational content of a broadcast is presented if the informational content is a preferred informational content.

In a variation of the method 900, rather than presenting preferred informational content, a list is presented in lieu thereof to a person using the mobile device. The list represents the broadcasts being received that have preferred informational content, and preferred informational content that is selected from the list by a person using the mobile device is presented. This variation of method 900 is particularly useful if numerous broadcasts are found in the received transmissions that contain preferred informational content.

### Presenting Proximate, Preferred Informational Content

In yet another related aspect, a mobile device is configured to present preferred informational content of a broadcast that is received from a transmitter determined to be within a predetermined proximity of the mobile device.

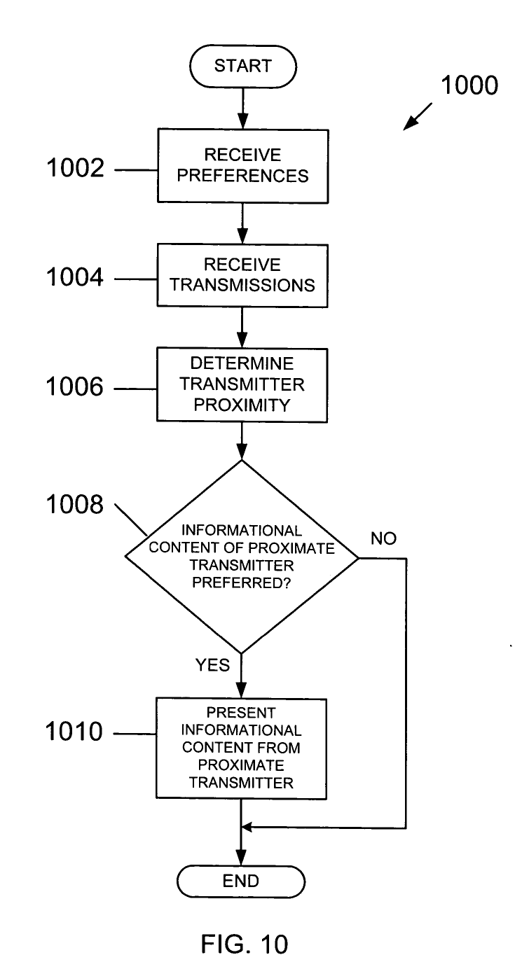

In this regard, FIG. 10 illustrates a general method 1000 utilized by such a mobile device. In step 1002, a person using the mobile device selects the types of informational content that are preferred. The preferences received by the mobile device in step 1002 preferably are recorded in a preferences profile for the person that is maintained within the mobile device.

Thereafter, in step 1004, a plurality of transmissions from wireless transmitters is received by the mobile device, wherein each such transmission includes at least one broadcast. In step 1006, a proximity of the transmitter for each received transmission is determined.

In step 1008, the broadcasts determined to come from transmitters within a predetermined proximity of the mobile device are scanned to determine if the informational content thereof matches informational content identified as being preferred in step 1002. Subsequently, the informational content of a broadcast is presented in step 1010 for which the informational content is determined to be preferred informational content.

In a variation of method 1000, preferred informational content of a broadcast is presented if the broadcast is received in a transmission from a transmitter that is determined to be nearest to the mobile device, rather than within a predetermined proximity to the mobile device. The nearest transmitter to the mobile device is identified by, again, determining the proximities of the transmitters from which transmissions are received by the mobile device.

Moreover, rather than presenting preferred informational content, a list may be presented in lieu thereof, especially if numerous broadcasts are determined to have preferred informational content during scanning. In this respect, the list represents the broadcasts being received from proximate transmitters which broadcasts have preferred informational content. Preferred informational content then is presented for the broadcasts that are selected from the list by a person using the mobile device.

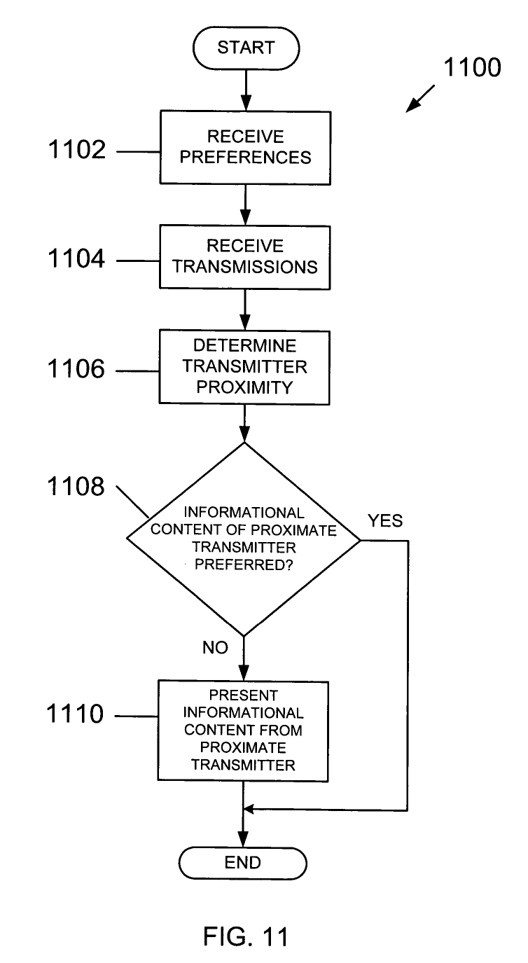

In method 1000 of FIG. 10, the stored preferences profile indicates types of informational content with which the person using the mobile device desires to be presented, i.e., that which is preferred. Similar to email and the problem that has arisen from spam and the solution of creating a “block sender” list, a similar problem and consequent solution may arise in systems and methods of the present invention. In this regard, the preferences profile actually may indicate informational content with which the person using the mobile device desires not to be presented. This variation is illustrated by method 1100 shown in FIG. 11.

Specifically, in step 1102, a person using the mobile device selects the types of informational content that are not preferred, and the preferences received by the mobile device in step 1102 preferably are recorded in a preferences profile for the person that is maintained within the mobile device.

Thereafter, in step 1104, a plurality of transmissions from wireless transmitters is received by the mobile device, wherein each such transmission includes at least one broadcast. In step 1106, a proximity of the transmitter for each received transmission is determined.

In step 1108, the broadcasts determined to come from transmitters within a predetermined proximity of the mobile device are scanned to determine if the informational content thereof matches informational content identified as not preferred in step 1102. Subsequently, informational content of a broadcast is not presented for which the informational content is determined not to be preferred informational content. Other informational content of a broadcast is presented in step 1110.

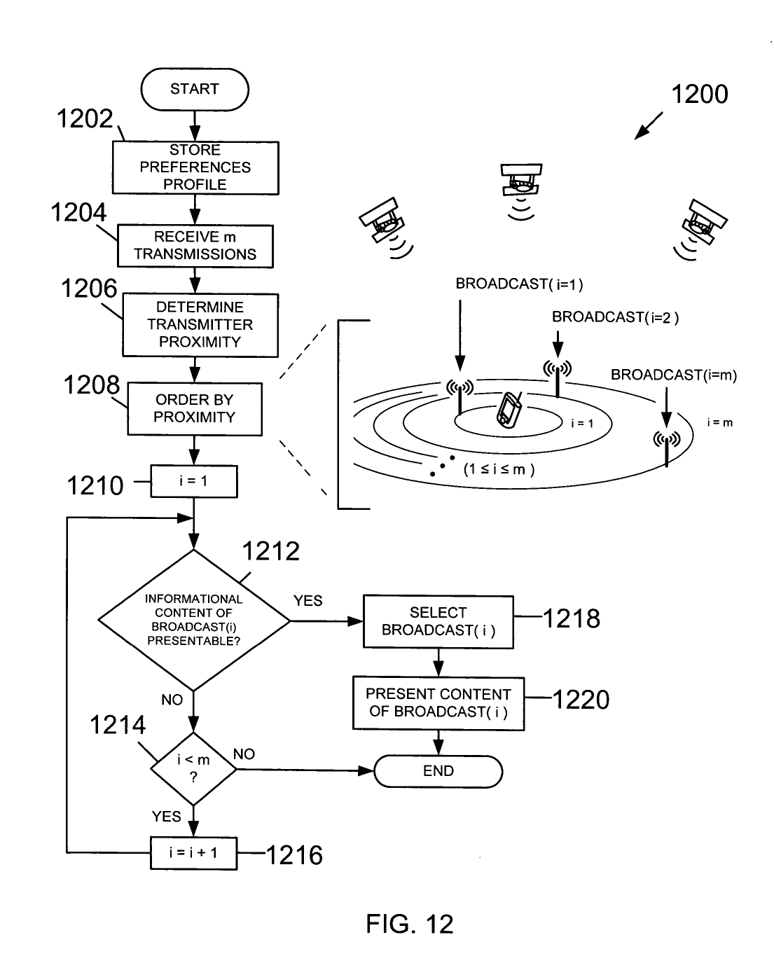

A method 1200 for determining proximity using GPS data and presenting preferred informational content from proximity transmitters based thereon is illustrated in FIG. 12. In particular, the method 1200 is for presenting informational content of a selected broadcast to a person using a mobile device that has stored therein a preferences profile indicating at least one type of informational content preferred for presentation. A broadcast is selected for presentation according to a transmitter proximity determination, and according to a determination of whether the informational content from a proximate transmitter is presentable according to the preferences profile. The preferred informational content of the closest transmitter is presented in accordance with this method 1200.

With specific reference to FIG. 12, a preferences profile from a person using a mobile device is stored in step 1202. Various examples of preferences profiles are within the scope of the embodiment of the invention. In a first example, the stored preferences profile indicates types of informational content with which the person using the mobile device desires to be presented. In such first example, a type of informational content is denoted as presentable if it matches a type of informational content indicated in the preferences profile. In a second example, the stored preferences profile indicates types of informational content with which the person using the mobile device does not desire to be presented. In such second example, a type of informational content is denoted as not presentable if it matches a type of informational content indicated in the preferences profile.

In step 1204, a plurality of transmissions is received from wireless transmitters by the mobile device, wherein each transmission includes a single broadcast conveying informational content for presentation. In FIG. 12, the integer “m” represents the number of received transmissions and, thus, the number of broadcasts.

In step 1206, a proximity of the transmitter for each received transmission is determined. In this regard, the mobile device preferably includes GPS capabilities, and transmitter proximity is determined utilizing positional data from each transmitter in conjunction with the GPS data of the mobile device.

In step 1208, the m received broadcasts are ordered according to increasing transmitter proximities such that a transmission having the greatest proximity to the mobile device is first in order. In FIG. 12, the integer “i” denotes an index by which the ordering is to be understood such that “i=1” denotes a transmission having the greatest proximity (i.e., is closest to the mobile device) and “i=m” denotes a transmission having the least proximity.

In step 1210, the integer “i” is set at a value of “1” for initiation of a process for determining the preferred informational content of a broadcast to present. The process begins with the transmission having the greatest determined proximity and proceeds in order of decreasing proximity until preferred informational content of a broadcast is presented.

In a first cycle of the process, in step 1212 it is determined whether the informational content of the broadcast denoted by “i=1” is presentable according to the preferences profile. If it is determined that the informational content is presentable (“YES”) then the broadcast denoted by “i=1” is selected as the particular broadcast in step 1218 and the informational content thereof is presented using the mobile device in step 1220. Otherwise, in step 1214, it is determined whether the current value of the integer “i” is less than the integer “m” wherein a negative determination denotes that the broadcasts of all transmissions currently received have been considered, and wherein a positive determination results in an increase in the integer “i” in step 1216 such that the informational content of the broadcast in the transmission denoted by “i=2” is next considered in step 1212. In this ordered fashion, the process continues until a broadcast having presentable informational content is selected and the informational content thereof is presented or until all broadcasts currently received have been considered and denied presentation.

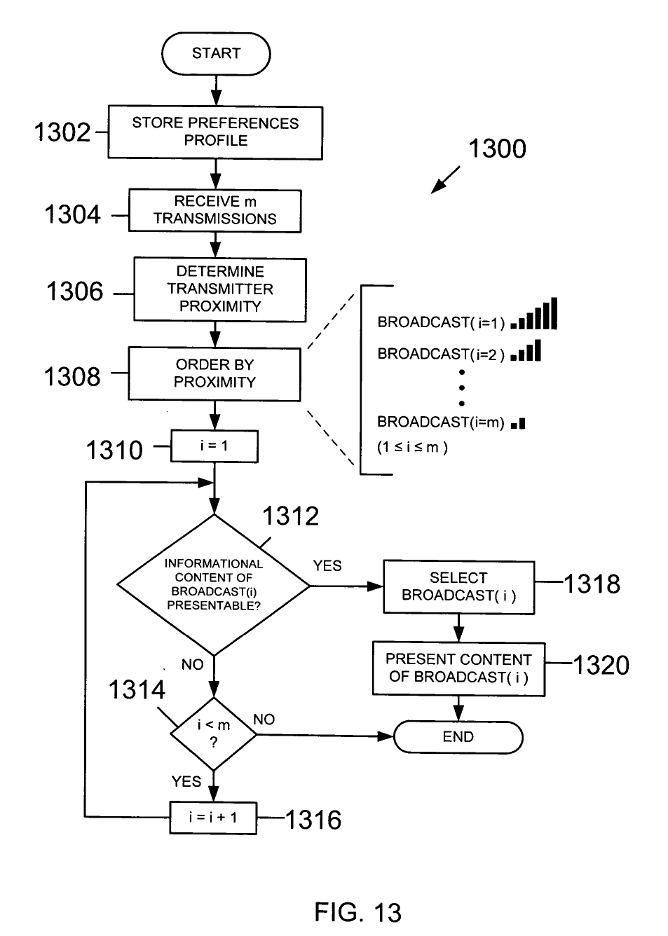

A method 1300 for determining proximity and presenting preferred informational content from proximity transmitters based thereon is illustrated in FIG. 13. In particular, the method 1300 is for presenting informational content of a selected broadcast to a person using a mobile device that has stored therein a preferences profile indicating at least one type of informational content preferred for presentation. A broadcast is selected for presentation according to a transmitter proximity determination, and according to a determination of whether the informational content from a proximate transmitter is presentable according to the preferences profile. The preferred informational content of the closest transmitter is presented in accordance with this method 1300.

With specific reference to FIG. 13, a preferences profile from a person using a mobile device is stored in step 1302. Various examples of preferences profiles are within the scope of the embodiment of the invention. In a first example, the stored preferences profile indicates types of informational content with which the person using the mobile device desires to be presented. In such first example, a type of informational content is denoted as presentable if it matches a type of informational content indicated in the preferences profile. In a second example, the stored preferences profile indicates types of informational content with which the person using the mobile device does not desire to be presented. In such second example, a type of informational content is denoted as not presentable if it matches a type of informational content indicated in the preferences profile.

In step 1304, a plurality of transmissions are received from wireless transmitters by the mobile device, wherein each transmission includes a single broadcast conveying informational content for presentation. In FIG. 13, the integer “m” represents the number of received transmissions and, thus, the number of broadcasts.

In step 1306, a proximity of the transmitter for each received transmission is determined. In this regard, the mobile device does not include GPS capabilities, and transmitter proximity is determined by measuring signal strength of received transmissions and deeming the transmitters to be at certain proximities as a function of the measured signal strength.

Furthermore, it should be noted that determining proximities as a function of measured signal strength is not as accurate as using GPS data and, consequently, this method generally is preferred in cases where GPS data is unavailable. Indeed, reflections from objects, shielding by intervening structures, attenuation by varying air and weather conditions, and spatial field patterns of transmissions from an antenna may each affect a correspondence between the strength of a signal at a receiver and the distance over which the signal is transmitted. Nonetheless, an approximation of true proximity can be made in many transmitter-receiver arrangements based on the signal strength of the transmission at reception since signal strength generally reduces with increasing distance from its transmitter.

In step 1308, the m received broadcasts are ordered according to increasing transmitter proximities such that a transmission having the greatest proximity to the mobile device is first in order. In FIG. 13, the integer “i” denotes an index by which the ordering is to be understood such that “i=1” denotes a transmission having the greatest proximity (i.e., is closest to the mobile device) and “i=m” denotes a transmission having the least proximity.

In step 1310, the integer “i” is set at a value of “1” for initiation of a process for determining the preferred informational content of a broadcast to present. The process begins with the transmission having the greatest determined proximity and proceeds in order of decreasing proximity until preferred informational content of a broadcast is presented.

In a first cycle of the process, in step 1312 it is determined whether the informational content of the broadcast denoted by “i=1” is presentable according to the preferences profile. If it is determined that the informational content is presentable (“YES”) then the broadcast denoted by “i=1” is selected as the particular broadcast in step 1318 and the informational content thereof is presented using the mobile device in step 1320. Otherwise, in step 1314, it is determined whether the current value of the integer “i” is less than the integer “m” wherein a negative determination denotes that the broadcasts of all transmissions currently received have been considered, and wherein a positive determination results in an increase in the integer “i” in step 1316 such that the informational content of the broadcast in the transmission denoted by “i=2” is next considered in step 1312. In this ordered fashion, the process continues until a broadcast having presentable informational content is selected and the informational content thereof is presented or until all broadcasts currently received have been considered and denied presentation.

### Avoiding Storing of Duplicative Informational Content

In aspects of the invention in which informational content is stored in non-volatile memory within the mobile device, the mobile device preferably is configured to avoid the storage of duplicative informational content as well as outdated informational content. In this regard, the mobile device performs a method of for identifying broadcasts for acquisition and storage of their informational content to the exclusion of other broadcasts.

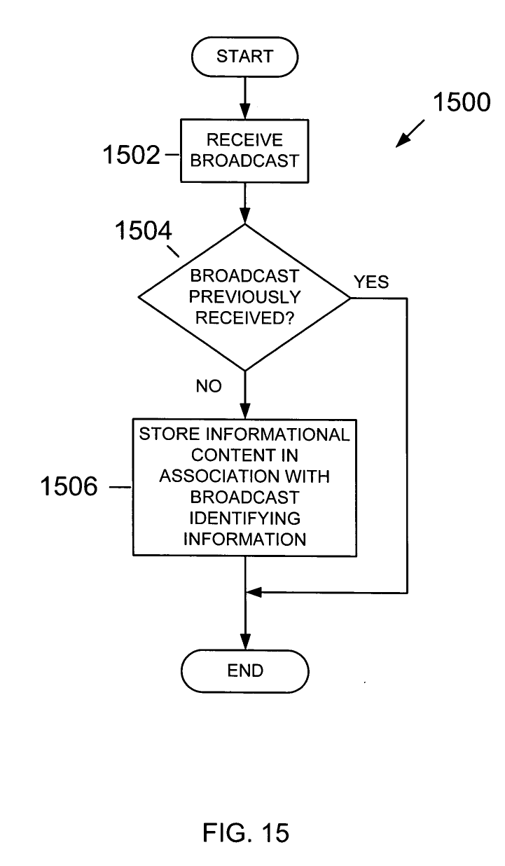

An exemplary such method 1500 is shown in FIG. 15, wherein a transmission containing a single broadcast is received in step 1502 that includes informational content for presentation to a person and broadcast-identifying information. In step 1504 it is determined whether the broadcast has previously been received by comparing the broadcast-identifying information of the respective broadcast with broadcast-identifying information of broadcasts previously received. If it is determined in step 1504 that the broadcast has not previously been received (“NO”), then the informational content of the broadcast is stored in step 1506 in association with the broadcast-identifying information thereof. Step 1504 adds to the number of broadcasts for which informational content is being stored in the mobile device.

On the other hand, if it is determined in step 1504 that the broadcast has been previously received (“YES”), then the informational content of the broadcast is not stored.

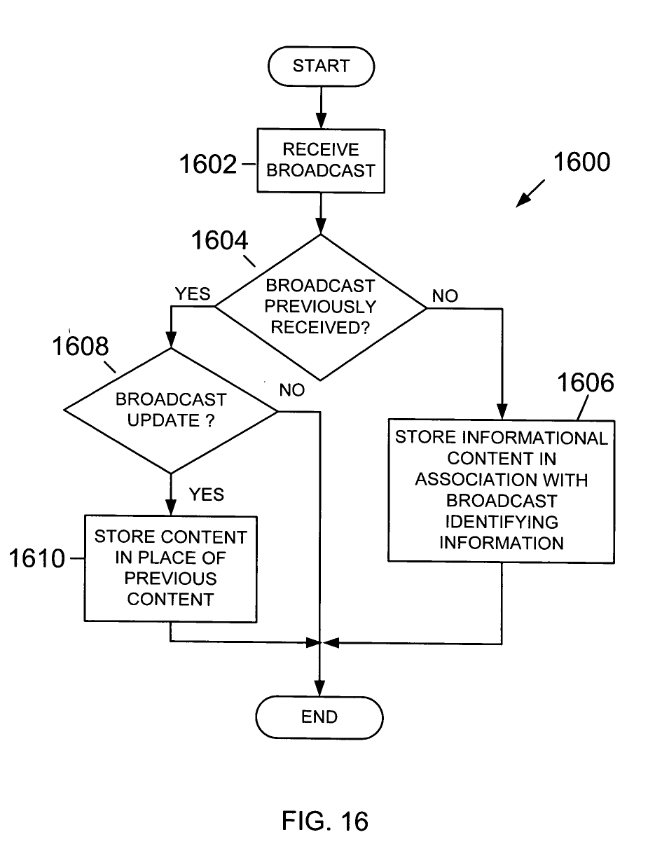

Another exemplary method 1600 is shown in FIG. 16, wherein a transmission containing a single broadcast is received in step 1602 that includes informational content for presentation to a person and broadcast-identifying information. In step 1604 it is determined whether the broadcast has previously been received by comparing the broadcast-identifying information of the respective broadcast with broadcast-identifying information of broadcasts previously received. If it is determined in step 1604 that the broadcast has not previously been received (“NO”), then the informational content of the broadcast is stored in step 1606 in association with the broadcast-identifying information thereof. As a result, step 1604 adds to the number of broadcasts for which informational content is being stored in the mobile device.

On the other hand, if it is determined in step 1604 that the broadcast has been previously received (“YES”), then a determination is made whether the broadcast of the received transmission is an update for that previously received. In this regard, the broadcast-identifying information does not uniquely identify or represent the informational content itself of the broadcast, and the broadcast-identifying information preferably further include an indication of the chronological order or version of the broadcast.

Thus, in method 1600 it further is determined in step 1608 whether the broadcast-identifying information includes an indication that the broadcast is an update for a previous broadcast. If such an indication is not found in step 1608 (“NO”), then the informational content of the received broadcast is not stored. If such an indication is found in step 1608 (“YES”), then the informational content of the received broadcast is stored in the mobile device. Preferably, however, the informational content is stored in place of the informational content of the previous broadcast having the matching broadcast identification.

### System and Method of Transmitter Network for Customized Broadcasting

In an aspect of the invention, a system comprises a connected network of wireless transmitters transmitting transmissions containing broadcasts of informational content for mobile device presentation.

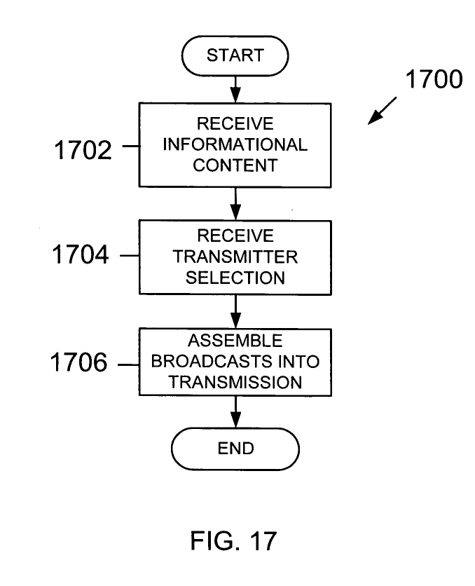

With regard to this aspect, an exemplary method 1700 for determining the broadcasts to be included in a particular transmission from a particular transmitter of the network is shown in FIG. 17. In step 1702, a first party receives from a second party informational content to be contained in a broadcast. In step 1704, the first party receives from the second party a selection of one or more wireless transmitters of the network for transmitting a transmission including the broadcast containing the informational content of the second party, and in step 1706, the first party assembles a plurality of broadcasts—one of which includes the informational content of the second party—for inclusion in a transmission from the wireless transmitter selected by the second party.

In accordance with method 1700, it should be appreciated that while only a single broadcast would include the informational content of the second party in the transmission, the other broadcasts of the transmission would include informational content of other parties. Moreover, this service by the first party preferably is provided to the second party (and other parties) under a subscription fee agreement. Furthermore, the first party may receive the informational content for inclusion in a broadcast over the Internet.

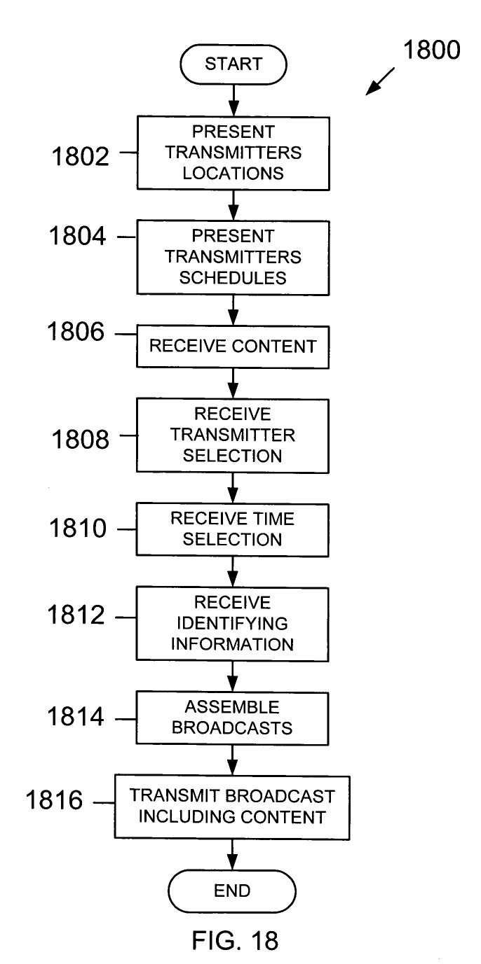

Another method 1800 in accordance with this aspect is shown in FIG. 18, wherein a first party presents in step 1802 to a second party descriptions of geographical locations of wireless transmitters of a network for consideration by the second party. In step 1804 the first party presents to the second party an identification of respective times at which transmissions are made from each transmitter of the network. In step 1806 the first party receives from the second party informational content to be contained in a broadcast, and in step 1808 the first party receives from the second party a selection of one or more wireless transmitters of the network for transmitting a transmission including the broadcast containing the informational content from the second party. In step 1810 the first party further receives from the second party a selection of one or more predetermined times for transmitting a transmission including the broadcast containing the informational content, and in step 1812 the first party further receives identifying-information from the second party. Thereafter, the first party assembles in step 1814 a plurality of broadcasts for inclusion in a transmission from a wireless transmitter selected by the second party. Preferably one of the broadcasts included in the transmission assembled contains the informational content and identifying-information received from the second party in step 1806. In step 1816 the method further comprises transmitting the transmission including the broadcast containing the informational content and identifying-information received from the second party.

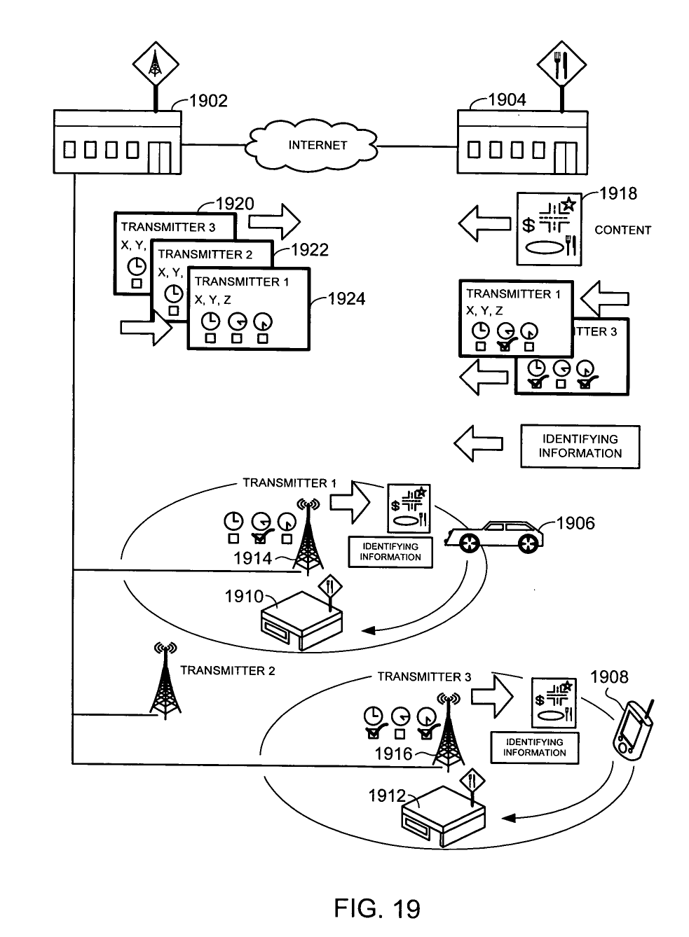

As an example of a particular practice of the method shown in FIG. 18, FIG. 19 illustrates a network of wireless transmitters of a first party 1902 transmitting transmissions including broadcasts of informational content of a second party 1904 for reception by mobile devices 1906 and 1908. Of course, it is to be understood that FIG. 19 provides an illustrative example, that FIG. 19 and descriptions thereof are not limiting of the methods of FIGS. 17 and 18, and that other particular practices are within the scope of the invention.

With further regard now to FIG. 19, in order that the second party 1904 may select appropriate transmitters and transmission times to reach an intended audience of the second party 1904, the first party 1902 sends data parcels 1920, 1922, 1924 over the Internet to the second party 1904. Each data parcel relates to a particular transmitter of the network and conveys an indication of the geographical location and transmission schedule of that particular transmitter, and the second party 1904 makes its desired location and time selections. In this example, the second party 1904 comprises a business having multiple restaurants 1910, 1912 that are located within transmission ranges of respective transmitters 1914, 1916 of the transmitter network of the first party 1902, and the second party 1904 seeks to provide informational content 1918 to the users of the mobile devices 1906, 1908, which users are potential customers for its, restaurants. Furthermore, in this example, the informational content 1918 includes graphical depictions, textual descriptions and current prices of menu items available at the restaurants. The second party 1904 selects particular transmitters 1914, 1916 according to the locations of the transmitters near to the restaurant locations 1910, 1912. The second party 1904 also makes transmission schedule selections in order to provide the informational content to mobile device users at favorable times. For example, the second party 1904 may prefer particular time ranges around particular meal times or around times of the day when vehicle or pedestrian traffic is heavy near particular restaurant locations.

The first party 1902 receives from the second party 1904 the informational content 1918, selections of transmitters preferred by the second party, and selections of times or time ranges for transmitting broadcasts containing the informational content. The first party 1902 assembles broadcasts for inclusion in transmissions from wireless transmitters of the network. A transmission of “transmitter 1” 1914, according to time schedule selections specified by the second party, includes a broadcast containing the informational content 1918.

Within the scope of this description, informational content may be uniform across various transmitters or may be specific to transmitters with variations there between. For example, insofar as the second party 1904 offers a uniform menu at multiple locations, the informational content 1918 is uniformly offered to potential customers (mobile device users) near any restaurant location of the second party 1904 and the informational content 1918 includes location information for the various locations. In other examples, however, each particular transmitter broadcasts informational content that is specific to each restaurant location, such as the uniform menu but location information for only the restaurant location nearest the particular transmitter. Furthermore, the menu items offered by the restaurant may vary throughout the course of a day and, accordingly, informational content contained in broadcasts may vary based on the time of transmission. Thus, transmitter selection, transmission time schedule selection, and informational content are separable parameters to be combined in various fashions according to preferences of the second party 1904, creating a highly customizable direct marketing approach.

Furthermore, though transmitters of the network are identified in the system of FIG. 19 to the second party by way of data parcels that include location and scheduling information, other modes are available within the scope of the invention for the first party to communicate detailed information about the transmitters and locations and schedules thereof, and for the second party to communicate its selections and provide informational content and identifying information. For example, the identity, location, and scheduling information regarding the transmitters could be provided by separate data parcels such as distinct computer files exchanged over the internet or contained on a storage medium such as a disk exchanged by mail or by courier. Also, the information could be presented by the first party and selections made by the second party by way of: email exchange; facsimile transmission exchanges; a voice discussion using a telephone connection; and a personal meeting between representatives of the parties at any location.

### Transmitting from a Specific Address

While perhaps more narrow in scope than the aspects discussed above, another aspect of the invention includes a system in which a wireless transmitter is located at a specific address and the informational content of a broadcast of a transmission that is made by the wireless transmitter pertains to the specific address.

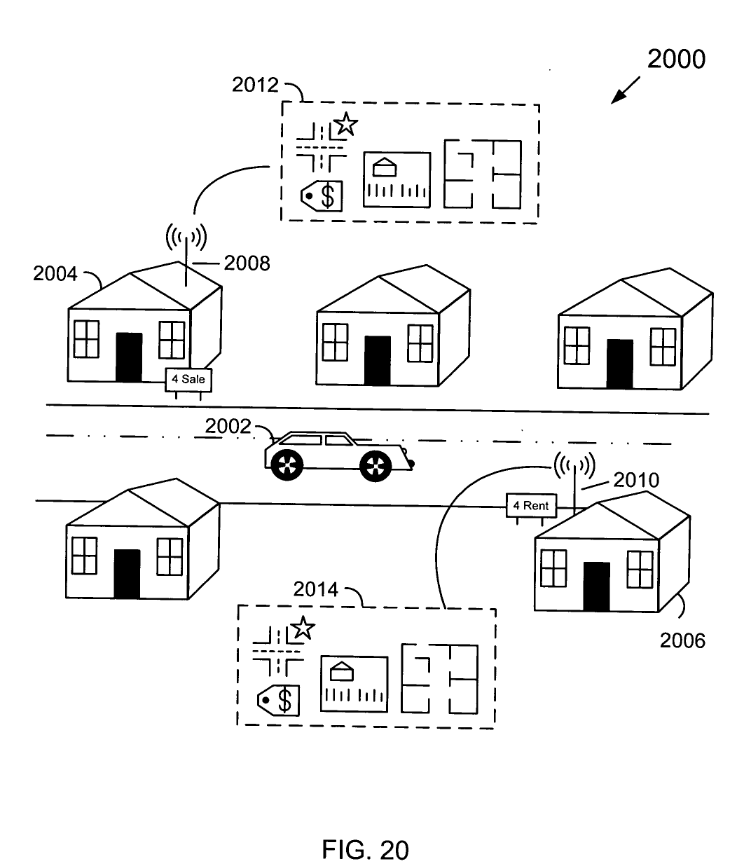

In this respect, a system 2000 is illustrated in FIG. 20 for presenting to a person using a mobile device informational content pertaining to a specific address when the mobile device is within proximity to the specific address. In this example, the mobile device comprises a motor vehicle 2002 traveling down a residential street, wherein the person within the vehicle is seeking housing. As shown in FIG. 20, house 2004 is for sale and house 2006 is for rent. Furthermore, because the person driving the motor vehicle happened to travel down this particular residential street, both of these options for housing were discovered.

In accordance with this aspect of the invention, a wireless transmitter 2008 is located at the address for the house 2004 that is for sale, and another wireless transmitter 2010 is located at the address for house 2006 that is for rent. Wireless transmitter 2008 transmits a transmission that contains a broadcast having informational content 2012 that pertains specifically to the house 2004 that is for sale, and wireless transmitter 2010 transmits a transmission that contains a broadcast having informational content 2014 that pertains specifically to the house 2006 that is for rent.

Conveniently, the informational content 2012 preferably includes an identification of the property by its specific street address; contact information for viewing of the house; a floor plan for the house; and sales information. Similarly, the informational content 2014 preferably includes an identification of the property by its specific street address; contact information for viewing of the house; a floor plan for the house; and rental information. Each informational content 2012, 2014 further may include the identification and contact information for a property owner of the house; or the identification and contact information for a property manager of the house.

Each wireless transmitter may be controlled by the owner of the house or an agent of the owner. Moreover, a real estate agent may control several wireless transmitters of the agent's clients. In this scenario, a computer preferably is connected to each of the wireless transmitters for controlling the wireless transmitter, whereby the agent can remotely control the transmissions of each of the wireless transmitters, including creating and distributing to each wireless transmitter the informational content for its respective specific locations.

With regard to this aspect of the invention, each transmitter transmits its transmission without regard to the detection of a mobile device within its transmission range. Alternatively, and with regard to this aspect of the present invention, each transmitter may only transmit its transmission upon detection of a mobile device, especially if the transmitter is battery powered so that the transmitter will operate over a longer period of time. An apparatus comprising the transmitter may include software for detecting when a mobile device comes within the transmission range of the transmitter, and for transmitting the transmission containing the broadcast when the mobile device is within range.

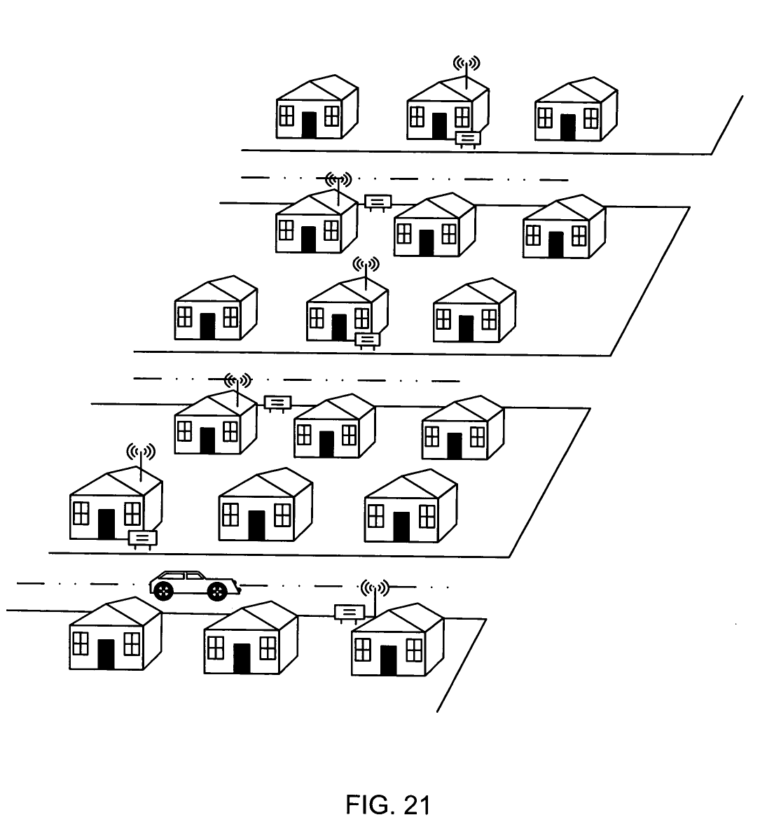

An immediate benefit of this aspect of the present invention is illustrated in FIG. 21, wherein an overview of the residential neighborhood of FIG. 20 is shown. But for the invention, the person would have to navigate the motor vehicle down each of the three roads shown in order to discover all of the housing options in the neighborhood. Utilizing the invention, however, the person need only drive down a single road without even visually scanning yards or otherwise searching for yard signs. As the person drive down the street and the mobile device comes within range of each wireless transmitter, its transmission is received by the mobile device and the informational content is either stored in the mobile device or directly presented to the person in accordance with any of the aforementioned aspects of the invention.

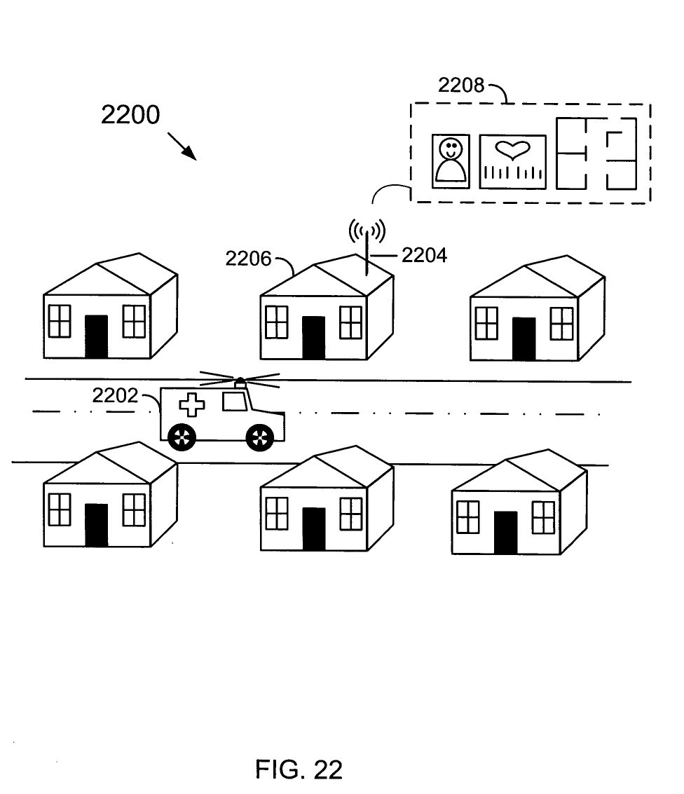

In further accordance with this aspect of the invention, another system 2200 is illustrated in FIG. 22 for presenting to a person using a mobile device informational content pertaining to a specific address when the mobile device is within proximity to the specific address. A wireless transmitter 2204 is located at the address for the house 2206 from which an emergency call originated and, in accordance with the aspect of the invention, the wireless transmitter 2204 transmits a transmission that contains a broadcast having informational content 2208 that pertains specifically to the house 2206.

The informational content 2208 preferably includes an identification of the property by its specific street address; a floor plan for the house; the identification of and contact information for an owner or occupant of the house; or medical information pertaining to an occupant of the house (such as whether the occupant is diabetic, has any drug allergies, etc.). The informational content 2208 further may include an alarm condition for the house and the identification of the particular sensor sounding the alarm; or the location and activation of emergency exits, fire alarms, and fire suppression systems.

It should be appreciated that, in this additional example, the mobile device comprises an emergency vehicle 2202 traveling down a residential street, wherein the person within the vehicle is responding to an emergency call; however, the emergency vehicle equally may represent a fire truck or police car responding to an emergency call. Moreover, while this aspect has been described with regard to residential real estate, the invention is equally applicable to commercial real estate. In this context, the informational content also may comprise an identification of the property by its specific street address; contact information for an occupant or business of the property; a floor plan for the building; rental information for the commercial real estate; mail and parcel receiving information; or delivery information for incoming packages and courier drop-offs and pickups.

### Distribution of Consolidated Informational Content Pertaining to Specific Locations

A last aspect of the invention includes a method for distributing informational content pertaining to specific locations for presentation to a person using a mobile device. The method as performed by the a first party includes the steps of receiving, by the first party, from each of a plurality of second parties, informational content pertaining to a specific location and location-identifying information for the specific location; maintaining by the first party in a database the received informational content pertaining to the specific locations in association with the received location-identifying information for the specific locations; and transmitting with a wireless transmitter a transmission, the transmission including a broadcast having the received informational content and the received location-identifying information as maintained in the database for a plurality of specific locations. A difference in this aspect over all aforementioned aspects is that a single broadcast consolidating the received informational content and the received location-identifying information as maintained in the database for a plurality of specific locations.

The method as performed with the mobile device in accordance with this aspect includes receiving a transmission including a broadcast, wherein the broadcast includes, for each of a plurality of specific locations, informational content pertaining to a specific location and location-identifying information for the specific location; storing, within the mobile device, for each of a plurality of specific locations, the received informational content in association with the received location-identifying information for the specific location; and identifying those specific locations that are within a predetermined proximity to the mobile device by searching the stored location-identifying information as a function of a current location of the mobile device.

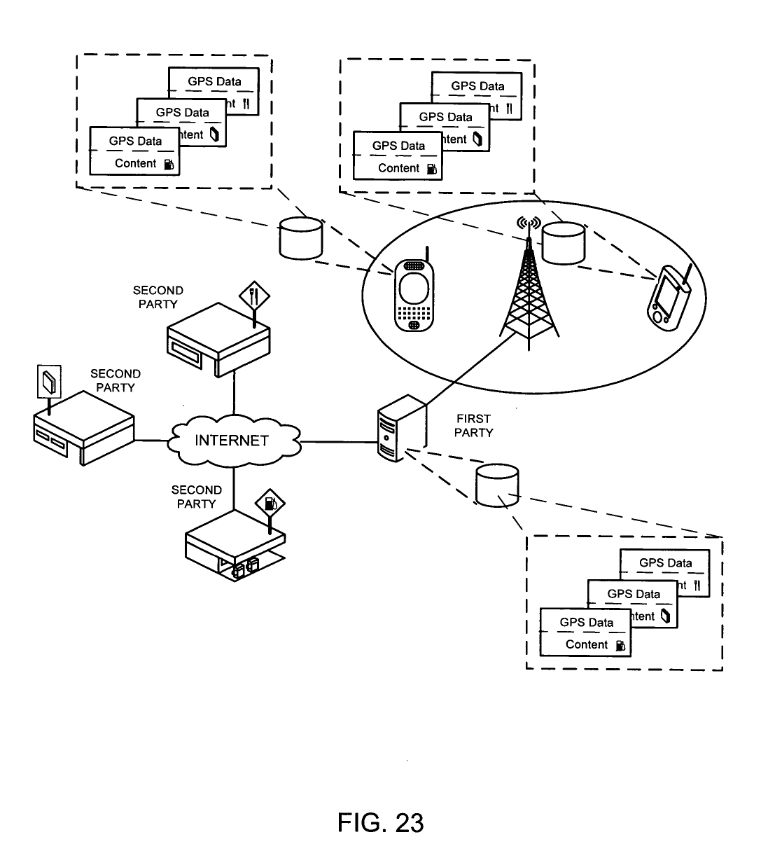

An exemplary system illustrating these two methods is shown in FIG. 23. It will be noted that the exemplary database of the first party, which is replicated in each of the mobile devices, associates GPS data with informational content pertaining to the location identified by the GPS data.

As will be appreciated, this aspect of the invention enables a person to acquire a database of informational content for an area of locations without first having to travel within certain proximities to the locations. In route or prior to traveling to the area, a person may simply acquire the information in a broadcast and thereafter data mine or filter the information as and when desired. Furthermore, if a database of GPS data for specific location and associated informational content is stored in the mobile device via this aspect of the present invention, then the method utilized by the mobile device further preferably includes the steps of updating and augmenting the database through periodic transmissions that are received.

In still yet a further feature, the first party receives over the Internet from one of the second parties informational content pertaining to a specific location and the location-identifying information for the specific location. In another feature, the first party provides a subscription service to each of the second parties under which the first party receives, from each of the second parties, the informational content pertaining to a specific location and the location-identifying information for the specific location. The subscription service may be provided to each of the second parties by the first party for a respective fee.

Transmitting may be performed repeatedly, whereby the informational content stored in association with the location-identifying information for the specific locations is kept current within the mobile devices. Alternatively, transmitting may be performed on a periodic basis, such as hourly or daily, whereby the informational content stored in association with the location-identifying information for the specific locations is kept current within the mobile devices.

1. An invention comprising an apparatus for presenting to a person using a mobile device informational content pertaining to a specific address when the mobile device is within proximity to the specific address, the apparatus comprising a wireless transmitter located at the specific address that transmits a transmission containing a broadcast, the broadcast comprising informational content for presenting to a person using the mobile device, the informational content pertaining to the specific address.

2. The invention of claim 1, wherein the transmitter unilaterally transmits the transmission without regard to whether the mobile device actually is within the transmission range of the transmitter.

3. The invention of claim 1, wherein the transmitter transmits the transmission upon detection of the mobile device within the transmission range of the transmitter.

4. The invention of claim 1, wherein the apparatus further comprises a machine-readable medium containing machine-executable instructions for detecting when the mobile device is within the transmission range of the transmitter, and transmitting the transmission containing the broadcast when the mobile device is within proximity to the specific address.

5. The invention of claim 1, wherein the apparatus further comprises a computer connected to the wireless transmitter for controlling of the wireless transmitter.

6. The invention of claim 5, wherein the computer further is connected to a computer network for receiving the informational content to be included in the broadcast of the transmission.

7. An invention comprising a method for presenting to a person using a mobile device informational content pertaining to a specific address when the mobile device is within proximity to the specific address, the method comprising the step of transmitting from the specific address a transmission containing a broadcast, the broadcast comprising informational content for presenting to a person using the mobile device, the informational content pertaining to the specific address.

8. The invention of claim 7, wherein the step of transmitting includes transmitting informational content comprising an identification of the property at the specific address.

9. The invention of claim 7, wherein the step of transmitting includes transmitting informational content comprising an identification of the number of occupants residing at the specific address.

10. The invention of claim 7, wherein the step of transmitting includes transmitting informational content comprising an identification of a legal name of an occupant of the specific address.

11. The invention of claim 7, wherein the step of transmitting includes transmitting informational content comprising contact information for an occupant of the specific address.

12. The invention of claim 7, wherein the step of transmitting includes transmitting informational content comprising an alarm condition for a building at the specific address.

13. The invention of claim 7, wherein the step of transmitting includes transmitting informational content comprising the location and activation of emergency exits, fire alarms, and fire suppression systems.

14. The invention of claim 7, wherein the step of transmitting includes transmitting informational content comprising a floor plan for a building at the specific address.

15. The invention of claim 7, wherein the step of transmitting includes transmitting informational content comprising sales information for real estate located at the specific address.

16. The invention of claim 7, wherein the step of transmitting includes transmitting informational content comprising rental information for real estate located at the specific address.

17. The invention of claim 7, wherein the step of transmitting includes transmitting informational content comprising mail and parcel receiving information.

18. The invention of claim 7, wherein the step of transmitting includes transmitting informational content comprising delivery information.
